(19) United States
(12) Patent Application Publication
(10) Pub. No.: US 2007/0188615 A1
(43) Pub. Date: Aug. 16, 2007

(54) Monitoring system, monitoring method, and monitoring program

(76) Inventors: Fumiko Beniyama, Yokohama (JP); Toshio Moriya, Tokyo (JP); Kosei Matsumoto, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/589,117

(22) Filed: Oct. 30, 2006

(30) Foreign Application Priority Data
Feb. 14, 2006 (JP) 2006-036082

(51) Int. Cl. H04N 5/225

(52) U.S. Cl. 348/207.99

(57) ABSTRACT

In the monitoring system that used fixed camera and movement camera, the technique is provided in which facilitates the route making and the movement control of the mobile robot in the remote place. The mobile image-taking device and a monitoring device are connected to each other via a communication network. The monitoring device stores map on the place to be monitored, and outputs the map to a display. Moreover, the monitoring system receives the taking image from a fixed camera, and outputs the image to a display. If abnormality is detected from the taking image of a fixed camera, the movement camera is moved to the abnormality occurrence position. The monitoring device transmits a route of the mobile monitoring device, which is inputted from an input device, to the mobile monitoring device. The mobile monitoring device moves in the place to be monitored according to the received route. The mobile monitoring device takes an image with a camera according to an instruction from the monitoring device, and transmits the taken image to the monitoring device.

### BACKGROUND OF THE INVENTION

The present invention relates to a monitoring system.

A conventional camera-setup monitoring system generally provides a method in which, in order to get hold of a situation in a wide area at one time, plural monitoring cameras are located above, and images which have been taken by the respective monitoring cameras are displayed by screen division at the same time, or selectively displayed, to thereby monitor whether an abnormality occurs, or not. Even in the above-mentioned monitoring technique using the fixed cameras, there is a technique in which setting of panning, tilting, or the like is changed to widen the image-taking range by the respective monitoring cameras, and there is a technique in which a specific person is traced by the plural fixed cameras.

However, with the fixed cameras, even if the panning, or tilting setup, or the like is changed, there is an angle at which an image cannot be obtained, such as an angle directed upward from a floor. A possible way to eliminate such locations includes a method in which a large number of cameras are set up above and below, all over the location. However, the method has a possibility of causing problems related to privacy. Also, this technique is accompanied by various difficulties in practical use such as difficulty in management because of too much information obtained from the cameras, and a significant amount of trouble and cost for installation, wiring, and maintenance.

Japanese Patent Laid-Open Publication No. 2004-297675 discloses a technique for taking an image of an object which is located in a position which cannot be viewed by panning, tilting, or zooming of the conventional fixed cameras, or for taking an image of an object which is hidden behind an obstacle. The publication discloses that a mobile image-taking device compares a reference image with a taken image to determine whether a predetermined image has been taken or not, and when the mobile image-taking device determines that the image has not been taken, moves within a predetermined range centered on the position of the object, and again takes an image of the object.

The technique disclosed in Japanese Patent Laid-Open Publication No. 2004-297675 is to merely move within a predetermined range in order to take an image of a given object. Accordingly, there is not proposed a way of bringing the mobile image-taking device that is a distance away from the object to a distance close enough for taking an image.

Also, there is a case in which an observer operates the mobile image-taking device by remote control. In this case, the observer ) gives instructions to turn right, turn left, or proceed on the basis of the image from the mobile image-taking device. In this case, the observer constantly needs to give instructions to turn right, turn left, or proceed, while giving attention to an input device for input of the instruction for the remote control. Also, in cases of controlling through the remote control, a delay may occur so that a smooth movement is not conducted.

Also, there is a technique in which a radio frequency identification system (RFID) or a marker is located on a floor of a place to be monitored, and the position of the mobile image-taking device is confirmed or the movement control is conducted according to information from the RFID or the marker. In this case, it is necessary to locate the RFID or the marker at the place to be monitored, and there are installation and management costs.

### SUMMARY OF THE INVENTION

The present invention has been made in view of the above-mentioned circumstances, and an object of the present invention is to provide a technique in which a mobile image-taking device is allowed to reach a destination without always being operated by an observer and without locating an RFID or a marker in a place to be monitored.

The present invention has been made to achieve the above-mentioned object, and is characterized in that the mobile image-taking device reaches the destination according to an inputted route.

According to an aspect of the present invention, there is provided a monitoring system, characterized in that the monitoring system includes: fixed cameras which set in a place to be monitored; a mobile monitoring device having moving means which moves in a place to be monitored; and a monitoring device which is connected to the mobile monitoring device via a communication network, the monitoring device including: monitor map memory means which stores map on a place to be monitored; display means which displays the map which is read from the monitor map memory means; means to receive image from fixed camera which set in a place to be monitored; means to detect abnormality occurrence place from the received image; input means; and mobile route transmitting means which transmits the route of the mobile monitoring device, which is inputted from the input means, to the mobile monitoring device, the mobile monitoring device including: movement monitoring map memory means which stores the map on the place to be monitored; setting value memory means which stores a setting value which determines at least one of the velocity and the traveling orientation of the moving means; movement control means which controls the moving means according to the setting value which is read from the setting value memory means; present position calculating means which calculates the present position from the map which is read from the movement monitoring map memory means; route receiving means which receives the transmitted route; and movement processing means; and in that the movement processing means calculates a value of the setting value from the calculated present position and the received route, and stores the setting value in the setting value memory means.

### BRIEF DESCRIPTION OF THE DRAWINGS

In the accompanying drawings:

FIG. 1 is a diagram showing a structural example of a system;

FIG. 2 is a diagram showing a structural example of a control section for a mobile monitoring camera device;

FIG. 3 is a diagram which explains a map of a place to be monitored;

FIG. 4 is a diagram showing an example of route information;

FIG. 5 is a diagram showing an example of movement parameters;

FIG. 6 is a diagram showing an example of image-taking parameters;

FIG. 7 is a diagram showing an example of lighting parameters;

FIG. 8 is a diagram showing a structural example of a monitoring device;

FIG. 9 is a diagram showing an example of fixed camera information;

FIG. 10 is a diagram showing an operational example of inputting an initial position;

FIG. 11 is a diagram showing a screen example;

FIG. 12 is a diagram showing an operational example of calculating a detailed initial position;

FIG. 13 is a diagram which explains an operational example of detecting an abnormality occurrence from an image of a fixed camera;

FIGS. 14A to 14F are diagrams which explain calculation of an abnormality occurrence position from an image;

FIG. 15 is a diagram showing an operational example of patrolling a place to be monitored by the mobile monitoring camera device;

FIG. 16 is a diagram showing an operational example of detecting an abnormality occurrence from a sensor data;

FIGS. 17A to 17C are diagrams which explain calculation of an abnormality occurrence position from a sensor data;

FIG. 18 is a diagram showing an operational example of retrieving a route which leads to a destination;

FIG. 19 is a diagram showing a screen example accepting the route;

FIGS. 20A and 20B are diagrams showing a screen example which displays an inputted route and a route calculated on the basis of the inputted route;

FIG. 21 is a diagram showing an operational example of moving the mobile monitoring camera device according to a transmitted route;

FIG. 22 is a diagram showing an operational example of moving the mobile monitoring camera device according to a transmitted route;

FIG. 23 is a diagram showing an operational example of instructing image-taking;

FIG. 24 is a diagram showing a screen example of instructing image-taking; and

FIG. 25 is a diagram showing an operational example of image-taking according to an instruction.

### DESCRIPTION OF THE PREFERRED EMBODIMENTS

Hereinafter, an embodiment will be described in detail with reference to the accompanying drawings.

In this embodiment, a moving device moves according to an inputted route. Hereinafter, a description will be given of an example in which a system according to this embodiment is applied to a monitoring system.

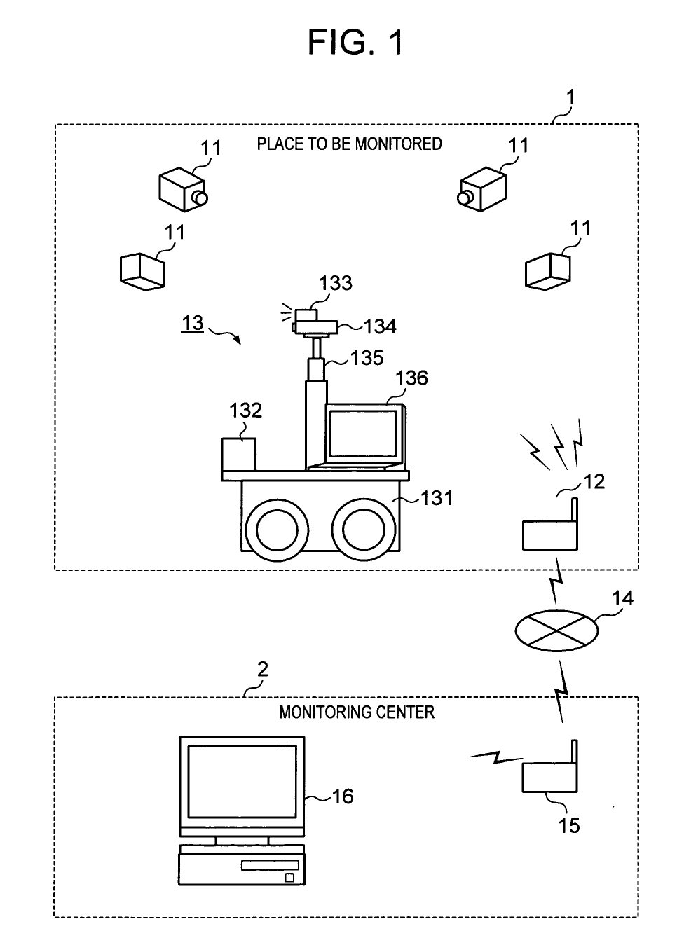

FIG. 1 is a diagram showing a system structure according to this embodiment. Referring to FIG. 1, this embodiment includes a place to be monitored 1 such as the interior of a building of a company, and a monitoring center 2 which monitors the place to be monitored 1. The place to be monitored 1 includes plural fixed cameras 11, a repeater 12, and a mobile monitoring camera device 13. The monitoring center 2 includes a repeater 15 and a monitoring device 16. For example, the monitoring system is so designed as to monitor the occurrence of abnormality in an unmanned state from when all company personnel have left the place to be monitored 1 at the end of working hours, until the next day's working hours start and any one of the company members arrives at the company.

The fixed cameras 11 are located at arbitrary positions in the place to be monitored 1. Each of the fixed cameras 11 includes a camera which takes an image, and a communication device (not shown) which transmits data of the image taken with the camera to the monitoring device 16 via the repeater 12. The image taken with each of the fixed cameras 11 may be a still image or a moving image.

In this embodiment, the moving image is taken with the fixed cameras 11. The fixed cameras 11 of the above-mentioned type are identical with conventional monitoring cameras.

The mobile monitoring camera device 13 includes a moving device 131, a sensor 132, lighting 133, a camera 134, a telescopic pole 135, and a control section 136. The moving device 131 moves the entire mobile monitoring camera device 13, and has wheels and a drive section. The sensor 132 is formed of, for example, a laser type displacement sensor, and measures distance to an object from the mobile monitoring camera device 13. For example, the sensor 132 is capable of measuring not only the distance to an object in front of the sensor 132, but also the distance to an object in a horizontal direction of the sensor 132 by rotating the sensor 132 together with a sensor head, by a given angle. The lighting 133 has a luminance adjusting function. The camera 134 has pan, tilt, and zoom functions. The image which is taken with the camera 134 may be a still image or a moving image. In this embodiment, the camera 134 takes the moving image. The telescopic pole 135 can be expanded or contracted within a given range. The control section 136 controls the moving device 131, the sensor 132, the lighting 133, the camera 134, and the telescopic pole 135, respectively. The control section 136 patrols along a given route within the place to be monitored 1, acquires information from the camera 134 or the sensor 132, and transmits the information to the monitoring device 16. In this embodiment, the control section 136 transmits the information which has been acquired from the sensor 132 on the patrol route. In addition, upon receiving the route, the destination, and image-taking conditions from the monitoring device 16, the control section 136 controls to realize movement following the route. The control section 136 controls taking of an image under the received image-taking conditions. The details of the control section 136 will be described below.

The moving device 131, the sensor 132, the lighting 133, the camera 134, and the telescopic pole 135 are identical with those in the conventional art.

The fixed camera 11 and the mobile monitoring camera device 13 are connected to the repeater 12 via, for example, a wireless local area network (LAN), Bluetooth, or a wire.

The repeater 12 and the repeater 15 are connected to each other on the communication network 14. The communication network 14 is, for example, the Internet, a public network, or an exclusive line.

The monitoring device 16 receives and displays the image which is transmitted from the fixed camera 11 and the mobile monitoring camera device 13. Also, upon detecting an abnormality from the information which has been transmitted from the fixed camera 11 and the mobile monitoring camera device 13, the monitoring device 16 calculates the abnormality occurrence position, and displays the calculated abnormality occurrence position and a map of the place to be monitored 1 on the output device. The monitoring device 16 transmits the inputted route and the image-taking condition to the device 13 by using the input device. Details of the monitoring device 16 will be described later.

The monitoring device 16 is connected to the repeater 15 via, for example, a wireless LAN, Bluetooth, or a wire.

The fixed camera 11, repeater 12, mobile monitoring camera device 13, repeater 15, and monitoring device 16 are not limited to the number of units thereof shown in FIG. 1, and the number thereof may be arbitrarily selected.

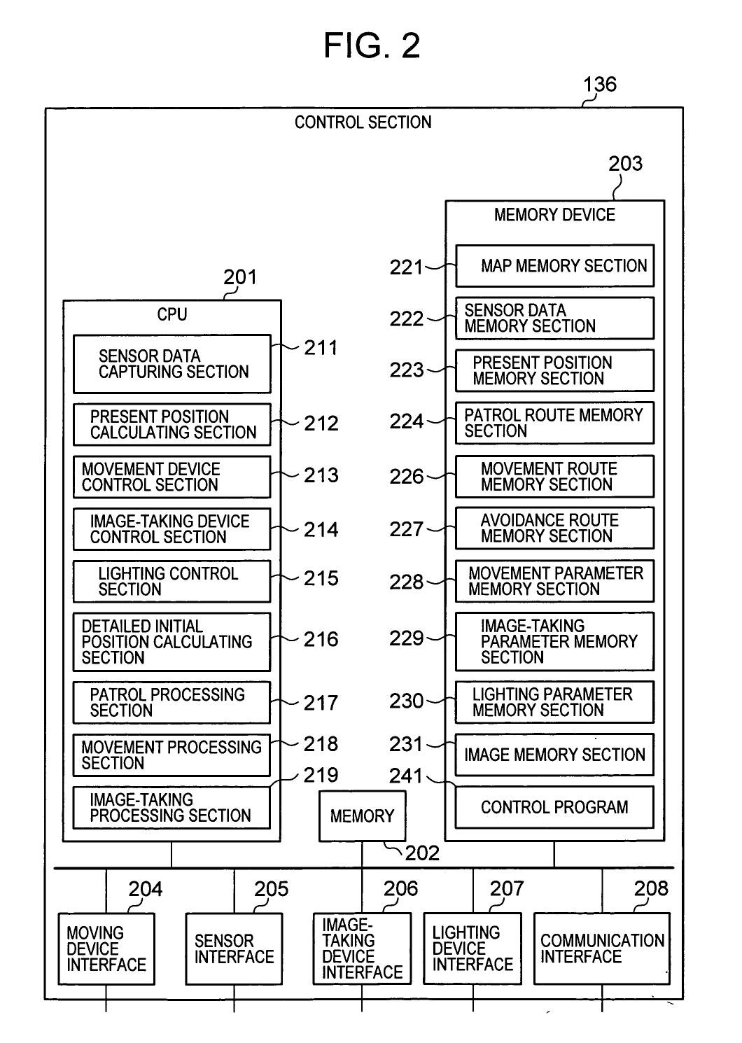

Next, details of the control section 136 will be described with reference to FIG. 2.

Referring to FIG. 2, the control section 136 is, for example, an information processing unit. The control section 136 includes a central processing unit (CPU) 201, a memory 202, a memory device 203, a moving device interface 204, a sensor interface 205, an image-taking device interface 206, a lighting device interface 207, and a communication interface 208. Those respective elements are connected to each other via a bus.

The memory device 203 includes storage media such as a compact disc-recordable (CD-R) or a digital versatile disk-random access memory (DVD-RAM), a drive section of the storage media, and an HDD (hard disk drive). The memory device 203 includes a map memory section 221, a sensor data memory section 222, a present position memory section 223, a patrol route memory section 224, a movement route memory section 226, an avoidance route memory section 227, a movement parameter memory section 228, an image-taking parameter memory section 229, a lighting parameter memory section 230, an image memory section 231, and a control program 241.

The map memory section 221 has map of the place to be monitored 1. The sensor data memory section 222 has a measured value which has been inputted from the sensor 132. The present position memory section 223 has the present position of the mobile monitoring camera device 13. The patrol route memory section 224 has a route along which the mobile monitoring camera device 13 patrols the place to be monitored 1 at a given timing. Hereinafter, the route along which the mobile monitoring camera device 13 patrols is called a “patrol route”. The movement route memory section 226 has a route which has been transmitted from the monitoring device 16. Hereinafter, the route which has been transmitted from the monitoring device 16 is called a “movement route”. The avoidance route memory section 227 has a route which avoids an obstacle which has been detected on the movement route which has been transmitted from the monitoring device 16. Hereinafter, a route which avoids the obstacle which has been detected on the movement route is called an “avoidance route”. The movement parameter memory section 228 has parameters for detecting the operation of the moving device 131. The image-taking parameter memory section 229 has parameters which are image-taking conditions which have been transmitted from the monitoring device 16. The lighting parameter memory section 230 has parameters which are the conditions of the lighting 133 at the time of image-taking. The image memory section 231 has image data that has been taken. The control program 241 is a program for realizing a function which will be described later.

The CPU 201 includes a sensor data capturing section 211, a present position calculating section 212, a movement device control section 213, an image-taking device control section 214, a lighting control section 215, a detailed initial position calculating section 216, a patrol processing section 217, a movement processing section 218, and an image-taking processing section 219. Those respective elements load the control program 241 which has been read from the memory device 203 in the memory 202, and the control program 241 is executed by the CPU 201.

The sensor data capturing section 211 captures the sensor data which is inputted from the sensor 132, and stores the sensor data in the sensor data memory section 222. The present position calculating section 212 calculates the present position of the mobile monitoring camera device 13 from a difference between the measured value from the acquired sensor 132 and the map within the map memory section 221, and stores the present position in the present position memory section 223. The movement device control section 213 controls the moving device 131 according to the parameters within the movement parameter memory section 228. The image-taking device control section 214 controls the camera 134 and the telescopic pole 135 according to the parameters within the image-taking parameter memory section 229, and stores the taken image data in the image memory section 231. The lighting control section 215 controls the lighting 133 according to the parameters within the lighting parameter memory section 230. The detailed initial position calculating section 216 controls the mobile monitoring camera device 13 so as to calculate the initial position of the mobile monitoring camera device 13 in an initial state. Hereinafter, the initial position of the mobile monitoring camera device 13 which is calculated in the initial state is called “detailed initial state”. The patrol processing section 217 controls the mobile monitoring camera device 13 so as to patrol within the place to be monitored 1 at a given timing, and to conduct the measurement by the sensor 132 at a given position of the patrol route. Upon receiving the movement route from the monitoring device 16, the movement processing section 218 stores the movement route in the movement route memory section 226, and further stores the parameters which are so calculated as to move along the received route in the movement parameter memory section 228. Also, upon detecting the obstacle on the movement route, the movement processing section 218 retrieves the avoidance route which avoids the detected obstacle, stores the retrieved avoidance route in the avoidance route memory section 227, and stores the parameters calculated so as to move along the stored avoidance route in the movement parameter memory section 228. Upon receiving the image-taking condition information such as the parameters from the monitoring device 16, the image-taking processing section 219 stores the information in the image-taking parameter memory section 229 and the lighting parameter memory section 230, and transmits the image data which has been read from the image memory section 231 to the monitoring device 16.

The moving device interface 204 is connected to the moving device 131. The sensor interface 205 is connected to the sensor 132. The image-taking device interface 206 is connected to the camera 134 and the telescopic pole 135. The lighting device interface 207 is connected to the lighting 133. The communication interface 208 is connected to the repeater 12.

Although not shown, the control section 136 can include an output device such as a display or a speaker, and an input device such as a keyboard, a mouse, a touch panel, or a button.

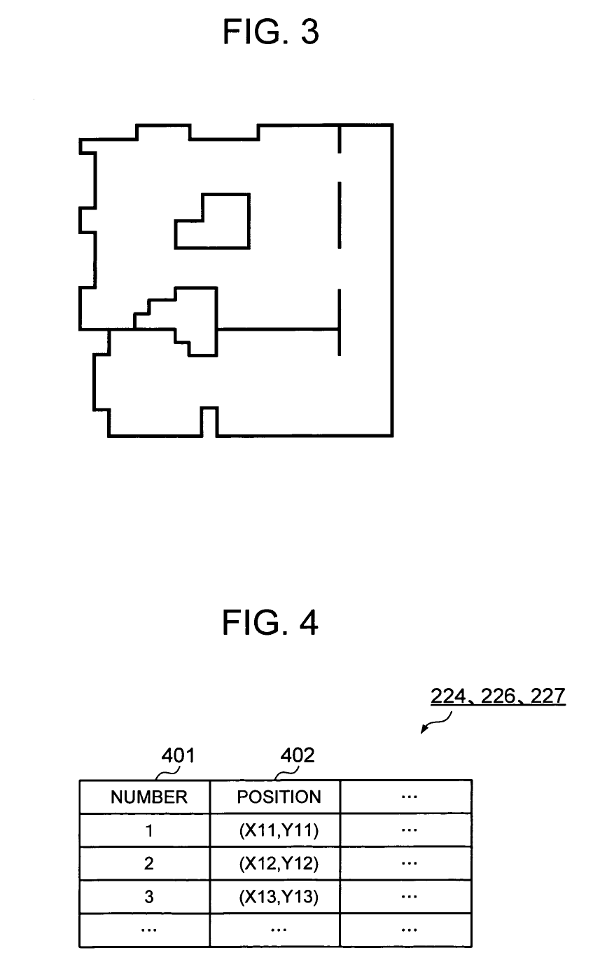

Next, a description will be given of the map used in this embodiment with reference to FIG. 3.

In this embodiment, the entire place to be monitored 1 is measured by means of the sensor 132 of the mobile monitoring camera device 13 in advance in a state where there is no one in the place to be monitored 1, and a map which has been obtained according to the measured values is called “map”. Therefore, the map is based on an area in which it is determined by the sensor 132 that there exists an object. FIG. 3 shows an example of the map of the place to be monitored 1 which is used in the following description. Referring to FIG. 3, bold lines indicate a contour of the object which has been measured by the sensor 132. In this embodiment, the map is indicated by X-Y coordinates.

An example of information stored in the memory device 203 will be described next.

The map memory section 221 stores the map shown in FIG. 3 as an example. In this embodiment, the image information of the map shown in FIG. 3 as an example and the X-Y coordinates at the respective positions of the image are stored in the map memory section 221.

Plural distances between a center and an object are stored in the sensor data memory section 222, the center being an arbitrary point on, for example, the mobile monitoring camera device 13. The respective distances are obtained by rotating the sensor head (not shown) of the sensor 132 by different angles such as 0 degrees, 5 degrees, and 10 degrees at the same position.

The X-Y coordinates indicative of the present position of the mobile monitoring camera device 13 are stored in the present position memory section 223. Although not described in this embodiment, the present position can include a direction of mobile monitoring camera device 13. The direction is, for example, four cardinal points or a direction based on an arbitrary point of the place to be monitored 1.

In this embodiment, the patrol route, the movement route, and the avoidance route are indicated by designating at least two X-Y coordinates of the map shown in the example of FIG. 3. Therefore, each of the patrol route, the movement route, and the avoidance route has two or more X-Y coordinates. Hereinafter, the X-Y coordinates of those routes are called “nodes”. Each of the patrol route, the movement route, and the avoidance route shown in this embodiment is different in only the specific X-Y coordinates, and since their elements are the same, an explanation will be given with one drawing as an example.

An example of tables stored within the patrol route memory section 224, the movement route memory section 226, and the avoidance route memory section 227 is shown in FIG. 4.

Referring to FIG. 4, each of the tables within the patrol route memory section 224, the movement route memory section 226, and the avoidance route memory section 227 includes numbers 401 and positions 402. The numbers 401 and the positions 402 are associated with each other. The numbers 401 are numbers of nodes at which mobile monitoring camera device 13 arrives. The positions 402 are positions of the nodes at which mobile monitoring camera device 13 arrives in the order of corresponding numbers 401. In this embodiment, the positions 402 are represented by the X-Y coordinates.

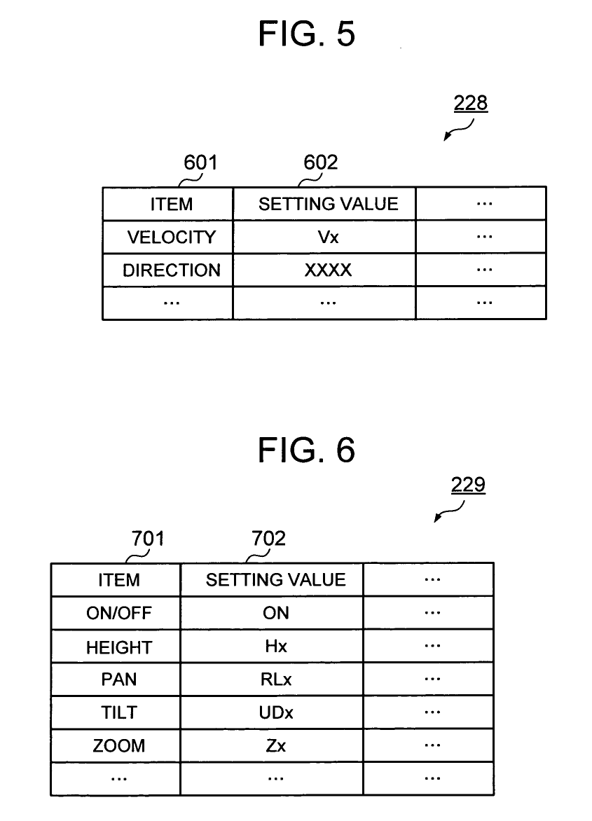

An example of the table within the movement parameter memory section 228 is shown in FIG. 5.

Referring to FIG. 5, the table within the movement parameter memory section 228 includes items 601 and setting values 602. The items 601 and the setting values 602 are associated with each other. The items 601 are items for moving the moving device 131. The item 601 “velocity” is a velocity of the moving device 131. The item 601 “direction” is a traveling direction of the moving device 131. The “direction” can be, for example, a value indicating an amount of direction change from a direction to which the moving device 131 is directed at the moment, or an absolute value based on the four cardinal points or an arbitrary point of the place to be monitored 1. The setting value 602 is a value of the item indicated by the corresponding item 601. In this embodiment, in the case where the mobile monitoring camera device 13 is going to stop, “0” is stored in the setting value 602 corresponding to the item 601 “velocity”. In cases where the mobile monitoring camera device 13 is going to move, an arbitrary velocity of “0” or more is stored in the setting value 602 corresponding to the item 601 “item”.

An example of the table within the image-taking parameter memory section 229 is shown in FIG. 6.

Referring to FIG. 6, the table within the image-taking parameter memory section 229 includes items 701 and setting values 702. The items 701 and the setting values 702 are associated with each other. The items 701 are items indicative of the conditions under which an image is taken with the camera 134. The item 701 “ON/OFF” indicates whether the image is taken with the camera 134, or not. In the example shown in FIG. 6, the setting value 702 “ON” corresponding to the item 701 “ON/OFF” indicates that the image is taken with the camera 134. Also, the setting value 702 “OFF” corresponding to the item 701 “ON/OFF” indicates that the image is not taken with the camera 134. The item “height” is a height of the telescopic pole 135. The “height” can be, for example, a variable value of the height of the telescopic pole 135 at the moment, or an absolute value of the height of the telescopic pole 135. The item 701 “pan” is a rotating angle in the horizontal direction of the camera 134. The rotating angle can be, for example, a variable value based on the present angle of the camera 134, or an absolute value based on a front surface of the camera 134. The item 701 “tilt” is a rotating angle in the vertical direction of the camera 134. The rotating angle can be, for example, a variable value based on the present angle of the camera 134, or an absolute value based on the evenness or the like of the camera 134. The setting value 702 is a value of the item indicated by the corresponding items 701.

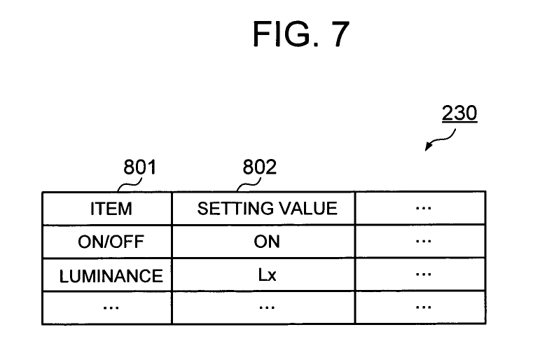

An example of the table within the lighting parameter memory section 230 is shown in FIG. 7.

Referring to FIG. 7, the table within the lighting parameter memory section 230 includes items 801 and setting values 802. The items 801 and the setting values 802 are associated with each other. The items 801 are items indicative of the conditions under which illumination is conducted by the lighting 133. The item 801 “ON/OFF” indicates whether illumination is conducted by the lighting 133, or not. In the example shown in FIG. 7, the setting value 802 “ON” corresponding to the item 801 “ON/OFF” indicates that illumination is conducted by the lighting 133. Also, the setting value 802 “OFF” corresponding to the item 801 “ON/OFF” indicates that illumination is not conducted by the lighting 133. The item 801 “luminance” is the luminance of the lighting 133. In this embodiment, the lighting 133 is fixed onto the camera 134. Therefore, in the case where the height and rotating angle of the camera 134 change, the height and rotating angle of the lighting 133 change according to the change in the height and rotating angle of the camera 134. In the case where the lighting 133 is not fixed onto the camera 134, control can be conducted so that the items such as “pan” or “tilt” of the above-mentioned image-taking parameter memory section 229 are included in the items 801 of the table within the image-taking parameter memory section 229. The setting value 802 is a value of the item indicated by the corresponding item 801.

Next, the image memory section 231 will be described. The image memory section 231 includes the image data which has been taken by the camera 134.

In this embodiment, the information within the map memory section 221, and the patrol route memory section 224 is stored in advance, but may be changed according to information which has been inputted from the communication interface 208 or an input device not shown. Also, the information within the sensor data memory section 222, the present position memory section 223, the movement route memory section 226, the avoidance route memory section 227, the movement parameter memory section 228, the image-taking parameter memory section 229, the lighting parameter memory section 230, and the image memory section 231 is sequentially updated according to the operation which will be described later.

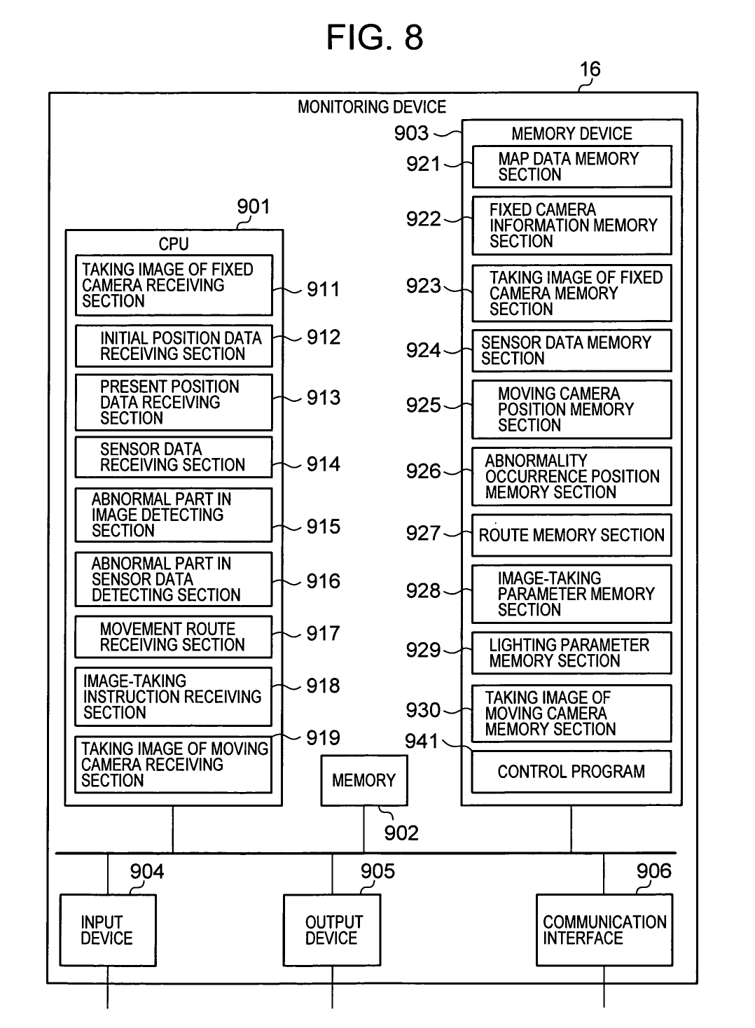

Now, the detail of the monitoring device 16 will be described with reference to FIG. 8.

Referring to FIG. 8, the monitoring device 16 is, for example, an information processing unit. The monitoring device 16 has a CPU 901, a memory 902, a memory device 903, an input device 904, an output device 905, and a communication interface 906. Those respective elements are connected to each other through a bus.

The memory device 903 is a storage media such as a CD-R or a DVD-RAM, a drive section of the storage media, or an HDD. The memory device 903 includes a map data memory section 921, a fixed camera information memory section 922, a taking image of fixed camera memory section 923, a sensor data memory section 924, a moving camera position memory section 925, an abnormality occurrence position memory section 926, a route memory section 927, an image-taking parameter memory section 928, a lighting parameter memory section 929, a taking image of moving camera memory section 930, and a control program 941.

The map data memory section 921 stores the map of the place to be monitored 1 therein. The map is identical with the information within the map memory section 221. The fixed camera information memory section 922 has installation positions and image-taking areas of the respective fixed cameras. The taking image of fixed camera memory section 923 has an image which is transmitted from the fixed cameras 11. The sensor data memory section 924 has a sensor data due to the sensor 132, which is transmitted from the mobile monitoring camera device 13. The moving camera position memory section 925 has the position of mobile monitoring camera device 13. The abnormality occurrence position memory section 926 has the position of the abnormality occurrence place in the place to be monitored 1, which is acquired from the image from the fixed cameras 11 or the sensor data from the mobile monitoring camera device 13. The route memory section 927 has a movement route. The image-taking parameter memory section 928 has a parameter being the movement conditions, which is transmitted to the mobile monitoring camera device 13. The lighting parameter memory section 929 has a parameter being the conditions of the lighting 133 at the time of taking the image. The taking image of moving camera memory section 930 has image data which is transmitted from the mobile monitoring camera device 13. The control program 941 is a program which realizes the functions which will be described later.

The CPU 901 executes the control program 941 which is read from the memory device 903 and loaded in the memory 902, to thereby realize a taking image of fixed camera receiving section 911, an initial position data receiving section 912, a present position data receiving section 913, a sensor data receiving section 914, an abnormal part in image detecting section 915, an abnormal part in sensor data detecting section 916, a movement route receiving section 917, an image-taking instruction receiving section 918, and a taking image of moving camera memory section 919.

Upon receiving the image data transmitted from the fixed cameras 11, the taking image of fixed camera receiving section 911 stores the image data in the taking image of fixed camera memory section 923. Also, the taking image of fixed camera receiving section 911 outputs the image data which has been read from the taking image of fixed camera memory section 923 to the output device 905. The initial position data receiving section 912 receives an input of the initial position of the mobile monitoring camera device 13 when, for example, the mobile monitoring camera device 13 is installed. Upon receiving the positional information of the mobile monitoring camera device 13 which is transmitted from the mobile monitoring camera device 13, the present position data receiving section 913 stores the positional information in the moving camera position memory section 925. Upon receiving the sensor data which is transmitted from the mobile monitoring camera device 13, the sensor data receiving section 914 stores the sensor data in the sensor data memory section 924. The abnormal part in image detecting section 915 determines whether there is an abnormality in the place to be monitored 1, or not, according to a difference of the image data taken on different dates which is read from the taking image of fixed camera memory section 923. In cases where there is an abnormality, the abnormal part in image detecting section 915 calculates the abnormality occurrence position. In this embodiment, the image data which has been taken by the respective fixed cameras 11 at dates when no abnormality occurs is stored in the taking image of fixed camera memory section 923 in advance. It is assumed that image data which has been taken by the same fixed camera 11 in a state with no abnormality is compared with image data taken on the latest date to detect the abnormality. The abnormal part in sensor data detecting section 916 determines whether there is an abnormality in the place to be monitored 1, or not, on the basis of a difference between the sensor data which has been read from the sensor data memory section 924 and the map which has been read from the map data memory section 921. In cases where there is an abnormality, the abnormal part in sensor data detecting section 916 calculates the occurrence position of the abnormality. The movement route receiving section 917 outputs the map which has been read from the map data memory section 921 to the output device. When the route is inputted, the movement route receiving section 917 retrieves a route which makes the costs minimum on the basis of the inputted route and the map, stores the retrieved route in the route memory section 927, and transmits the retrieved route to the mobile monitoring camera device 13. The image-taking instruction receiving section 918 transmits the condition information to the mobile monitoring camera device 13 upon receiving the image-taking instruction and inputting the image-taking conditions. The taking image of moving camera memory section 919 receives the image data which has been transmitted from the mobile monitoring camera device 13, and stores the image data in the taking image of moving camera memory section 930. In addition, the taking image of moving camera memory section 919 outputs the image data which has been read from the taking image of moving camera memory section 930 in the output device 905.

The input device 904 is, for example, a keyboard, a mouse, a scanner, or a microphone. The output device 905 is, for example, a display, a speaker, or a printer. The monitoring device 16 is connected to the repeater 15 through the communication interface 906.

Now, an example of the information within the memory device 903 will be described.

The information which is stored within the map data memory section 921 is identical with the above-mentioned map memory section 221, and their description will be omitted.

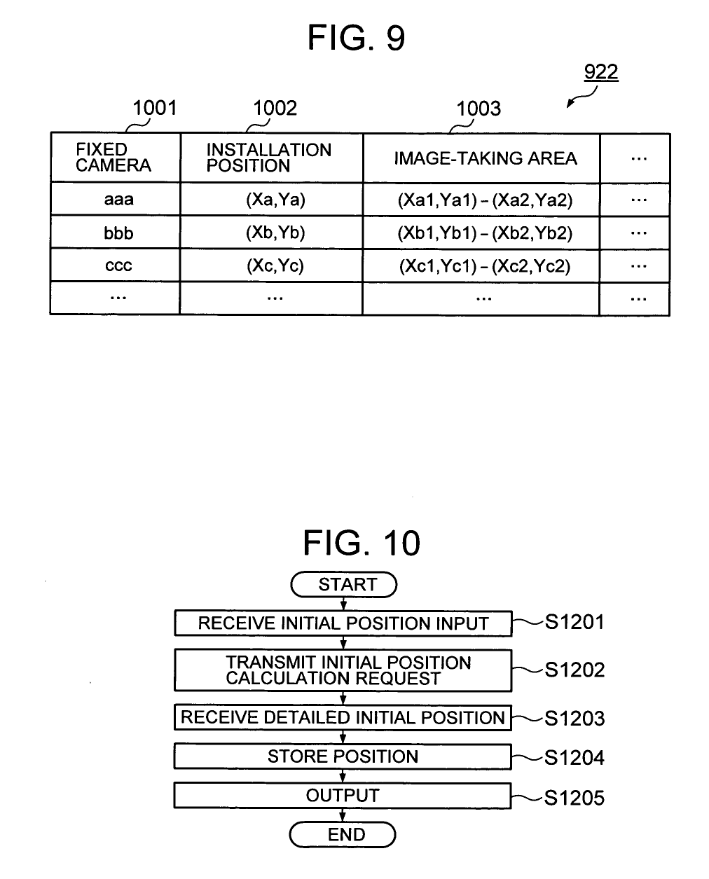

An example of the table within the fixed camera information memory section 922 is shown in FIG. 9.

Referring to FIG. 9, the table within the fixed camera information memory section 922 includes fixed cameras 1001, installation positions 1002, and image-taking areas 1003. The fixed cameras 1001, the installation positions 1022, and the image-taking areas 1003 are associated with each other. The fixed cameras 1001 are identification information of the fixed cameras 11. The installation positions 1002 are positions of the corresponding fixed cameras 1001. In an example shown in FIG. 9, the installation positions 1002 are X-Y coordinates. The image-taking areas 1003 are areas which can be taken by the corresponding fixed cameras 1001. In the example shown in FIG. 9, the image-taking areas 1003 are represented by the diagonal X-Y coordinates of the rectangular area.

The taking image of fixed camera memory section 923 stores therein the image data which has been taken by the fixed camera 11. The image data includes the identification information of the fixed camera 11 which has taken the image data, and a date when the image data has been taken. The date can be transmitted from the fixed camera 11 together with the image data, or can be a date of reception which has been acquired from an internal clock when the monitoring device 16 receives the image data from the fixed camera 11.

In this embodiment, it is assumed that the image data which has been taken by the respective fixed camera 11 on a date when no abnormality occurs is included in the taking image of fixed camera memory section 923. For example, the image data is taken by the respective fixed cameras 11 in a state where there is no one in the place to be monitored 1 in advance as with the above-mentioned map. The following description will be made on the premise that a flag (not shown) is given to the image data taken on a date when no abnormality occurs.

The information within the moving camera position memory section 925 will be described. The moving camera position memory section 925 stores the present position information therein. The present position information includes the X-Y coordinates indicative of the present position of the mobile monitoring camera device 13, and data on which the present position is calculated. The date can be date information which has been transmitted together with the present position which is transmitted from the mobile monitoring camera device 13, or a date of reception which has been acquired from the internal clock when the monitoring device 16 has received the present position.

The information within the abnormality occurrence position memory section 926 will be described. The abnormality occurrence position memory section 926 stores therein information indicative of the abnormality occurrence position which is calculated according to the operation which will be described later. In this embodiment, it is assumed that the abnormality occurrence position is indicated by one set of X-Y coordinates. Also, in cases where there are plural abnormality occurrence positions, the X-Y coordinates of the respective abnormality occurrence positions are stored in the abnormality occurrence position memory section 926.

One abnormality occurrence position is not limited to one X-Y coordinates indication, and can also be expressed by, for example, plural X-Y coordinates, or an area represented by one set of X-Y coordinates and a given distance.

The information within the route memory section 927 will be described. The route memory section 927 stores therein two or more X-Y coordinates which are indicative of the route. An example of the route memory section 927 is identical with the patrol route memory section 224, the movement route memory section 226, and the avoidance route memory section 227, which are shown in FIG. 4 described above as one example. Therefore, their descriptions will be omitted.

Next, the information within the taking image of moving camera memory section 930 will be described. The taking image of moving camera memory section 930 includes the image data which has been taken with the camera 134 and transmitted to the mobile monitoring camera device 13. The image data includes a date at which the image data has been taken. The date can be a date which has been transmitted from the camera 134 together with the image data, or a date of reception which has been acquired from the internal clock when the monitoring device 16 has received the image data from the camera 134.

It is assumed that the information within the map data memory section 921 and the fixed camera information memory section 922 is stored in advance, but maybe updated according to the information which has been inputted through the communication interface 906. Also, the information within the taking image of fixed camera memory section 923, the sensor data memory section 924, the moving camera position memory section 925, the abnormality occurrence position memory section 926, the route memory section 927, the image-taking parameter memory section 928, the lighting parameter memory section 929, and the taking image of moving camera memory section 930 is stored according to an operation which will be described later, and updated.

Now, operation examples will be described.

First, the operation example of setting the detailed initial position of the mobile monitoring camera device 13 will be described.

The operation described below is an operation conducted as the initial setting when the monitoring system according to this embodiment is introduced. First, the fixed cameras 11 are located in the place to be monitored 1, and the mobile monitoring camera device 13 is located in an arbitrary position of the place to be monitored 1. Thereafter, in the operational example which will be described later, an observer specifies the position of the place to be monitored 1 to indicate roughly the place in which the mobile monitoring camera device 13 is located. Then, the mobile monitoring camera device 13 compares the measured value of the sensor 132 with the map in the vicinity of the specified place, to thereby calculate a more accurate initial position. Hereinafter, a description will be given of the operational example of the monitoring device 16 with reference to FIG. 10, and of the operational example of the mobile monitoring camera device 13 with reference to FIG. 12.

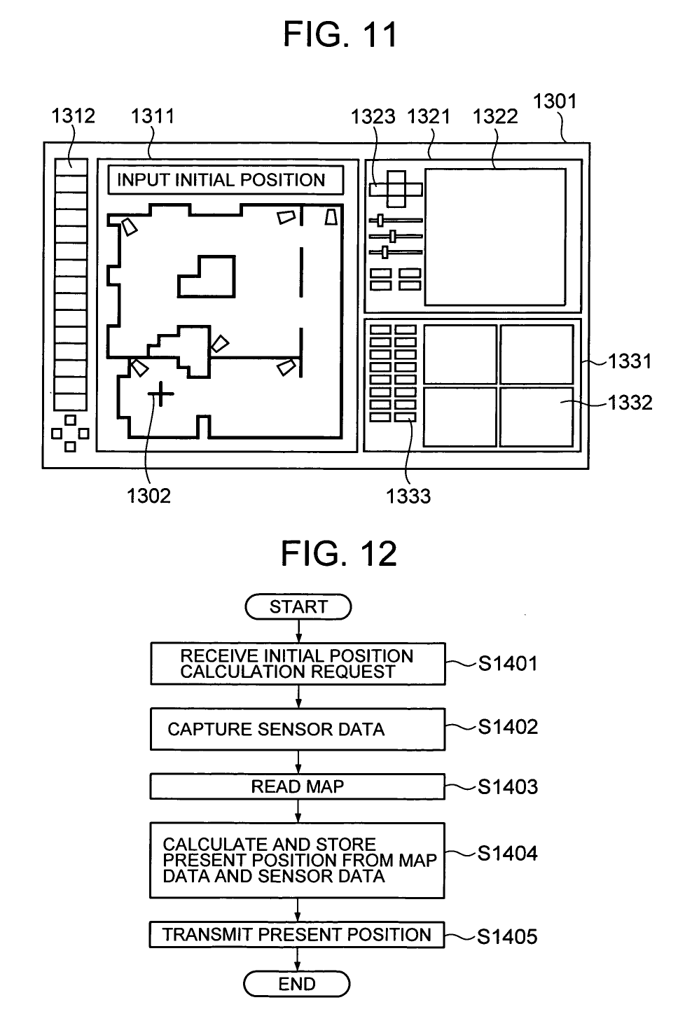

First, the operational example of the monitoring device 16 will be described. Referring to FIG. 10, the initial position data receiving section 912 first receives an input in the vicinity of the initial position of the mobile monitoring camera device 13 (S1201) Then, the initial position data receiving section 912 displays the map of the place to be monitored 1 on a screen shown in a screen 1301 of FIG. 11 as one example in the output device 905 such as a display. The screen 1301 reads the map data memory section 921 from the memory device 903, and displays according to a given format. The screen exemplified by the screen 1301 becomes an interface for monitoring through the observer by means of the monitoring system of this embodiment. The screen 1301 has a sub-screen 1311, a monitor operation button 1312, a sub-screen 1321, and a sub-screen 1331. The sub-screen 1311 is an area on which the map of the place to be monitored 1 is displayed. On the map, the mobile monitoring camera device 13 and the fixed cameras 11 are positioned and displayed. The monitor operation button 1312 is made up of plural buttons for inputting the operation instructions of the fixed cameras 11 and the mobile monitoring camera device 13. The sub-screen 1321 includes a display area 1322 and a moving camera operation button 1323. The display area 1322 is an area on which an image which has been taken with the mobile monitoring camera device 13 is displayed. The moving camera operation button 1322 is made up of plural buttons for setting the parameters of the lighting 133, the camera 134, and the telescopic pole 135. The sub-screen 1331 has image output areas 1332 and buttons 1333. Each of the image output areas 1332 is an area for outputting the image which has been taken by one fixed camera 11. The buttons 1333 are so designed as to switch over the images which are outputted to the respective image output areas 1332.

The observer specifies the vicinity of a position at which the mobile monitoring camera device 13 is located on the map displayed on the sub-screen 1311. In an example of FIG. 11, it is assumed that a position denoted by reference numeral 1302 is designated. The initial position data receiving section 912 sets the X-Y coordinates of the position which has been inputted using the input device 904 to the vicinity of the initial position of the mobile monitoring camera device 13.

Referring to FIG. 10, the initial position data receiving section 912 transmits an initial position calculation request including the vicinity of the initial position which has been received in the processing of S1201 to the mobile monitoring camera device 13 (S1202). To achieve the above-mentioned operation, for example, the initial position data receiving section 912 transmits the initial position calculation request including the X-Y coordinates, which have been inputted according to the above operational example, to the mobile monitoring camera device 13.

Through the operational example which will be described later, the mobile monitoring camera device 13 compares the vicinity of the transmitted initial position with the measured value of the sensor 132, to thereby calculate the more accurate initial position. The mobile monitoring camera device 13 transmits the calculated initial position to the monitoring device 16.

Upon receiving the initial position which has been transmitted from the mobile monitoring camera device 13 (S1203), the initial position data receiving section 912 stores the initial position in the moving camera position memory section 925 (S1204), and outputs information having the initial position superimposed on the map of the place to be monitored 1 to the output device 905 such as a display (S1205).

Next, the operational example of the mobile monitoring camera device 13 will be described. Referring to FIG. 12, upon receiving the initial position calculation request including the vicinity of the initial position from the monitoring device 16 (S1401), the detailed initial position calculating section 216 of the control section 136 in the mobile monitoring camera device 13 acquires the measured value from the sensor 132 (S1402). To achieve the above-mentioned operation, for example, the detailed initial position calculating section 216 instructs the acquisition of the measured value due to the sensor 132 to the sensor data acquiring section 211. The sensor data acquiring section 211 allows the sensor 132 to measure a distance to an object within a given area in the horizontal direction of the sensor 132, and stores the measured value in the sensor data memory section 222.

The detailed initial position calculating section 216 reads the map in the vicinity of the initial position included in the initial position calculation request which has been received in Step S1401 (S1403). To achieve the above-mentioned operation, for example, the detailed initial position calculating section 216 reads the map within the given area with its center being on the X-Y coordinates in the vicinity of the initial position included in the initial position calculation request from the map memory section 221 of the memory device 203.

Next, the detailed initial position calculating section 216 instructs the calculation of the present position to the present position calculating section 212. The present position calculating section 212 calculates the present position of the mobile monitoring camera device 13 from a difference between the map to be compared and the sensor data captured in S1402 with the map read in S1403 as the map to be compared according to the instruction, and stores the present position in the present position memory section 223 (S1404).

Returning to FIG. 12, the detailed initial position calculating section 216 reads the present position information from the present position memory section 223, and transmits the present position information to the monitoring device 16 when the present position calculating section 212 calculates the initial position of the mobile monitoring camera device 13 (S1405).

Now, the operational example of detecting the abnormality of the place to be monitored 1 by means of the monitoring device 16 will be described.

As a technique for detecting the abnormality of the place to be monitored 1 by means of the monitoring device 16, a description will be given of an example of detecting the abnormality according to a difference of the images which has been transmitted from the fixed cameras 11 and an example of detecting the abnormality according to a difference of the measured values from the sensor 132. The examples of detecting the abnormality are not limited to the above examples. The abnormality can also be detected, for example, according to the image which has been taken with the camera 134 of the mobile monitoring camera device 13. This operational example is identical with that of the image which has been transmitted from the fixed cameras 11 which will be described below, and therefore its description will be omitted.

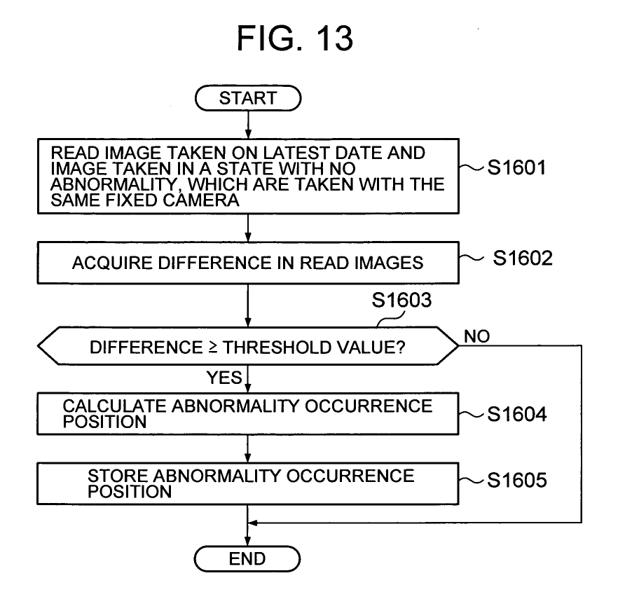

First, the operational example of the monitoring device 16 which detects the abnormality of the place to be monitored 1 according to the difference of the images which are transmitted from the fixed cameras 11 will be described with reference to FIG. 13.

As described above, the fixed cameras 11 transmit the taken image data to the monitoring device 16. For example, each of the fixed cameras 11 transmits the taken image data to the monitoring device 16 as needed, such as 30 frames per 1 second. In this situation, the fixed camera 11 adds its identification information to data to be transmitted, and then transmits the data to the monitoring device 16 on the communication network 14. Upon receiving the image data from the fixed camera 11, the taking image of fixed camera receiving section 911 of the monitoring device 16 stores the received data in the taking image of fixed camera memory section 923. In this situation, in cases where no date of the taken image is included in the received data, the taking image of fixed camera receiving section 911 acquires the data receiving date from the internal clock, adds the acquired date to the data, and stores the data in the taking image of fixed camera memory section 923. The taking image of fixed camera receiving section 911 displays the image data which has been read from the taking image of fixed camera memory section 923 on the image output area 1332 of the sub-screen 1331 which is exemplified by FIG. 11.

The abnormal part in image detecting section 915 of the monitoring device 16 receives the data from the fixed camera 11, starts every time the taking image of fixed camera memory section 923 is updated, and conducts the operation which is exemplified by FIG. 13. First, the abnormal part in image detecting section 915 reads the latest image data which has been taken by the respective fixed cameras 11 and the image data which has been taken by the same fixed cameras 11 on a date when no abnormality occurs (S1601). To achieve the above-mentioned operation, for example, the abnormal part in image detecting section 915 reads the frame of the image data which includes the date in which the latest image is taken, and the frame of the image data which includes the same identification information as that of the image data, and is given a flag indicating that the image has been taken on a date when no abnormality occurs.

The abnormal part in image detecting section 915 acquires a difference between two image data which are read in S1601 (S1602) The difference is, for example, a differential image acquired by binarizing each of the two frame images which have been read in S1601, and calculating a difference in pixels at the same position. The operational example of obtaining the differential image is identical with that of the image processing in the conventional art.

The abnormal part in image detecting section 915 determines whether the difference which is calculated in S1602 is equal to or higher than a given threshold value, or not (S1603). The threshold value is, for example, the number of pixels of the binarized differential image, and can be arbitrarily set according to the information which is inputted from the input device 904 or the communication interface 906.

In cases where the difference is equal to or higher than the threshold value as a result of determination in S1603, the abnormal part in image detecting section 915 determines that the abnormality is present, and calculates the position of the abnormality occurrence location (S1604). A technique for calculating the abnormality occurrence location is not particularly limited. In this embodiment, the abnormality occurrence position is calculated on the basis of conventional three-point measurement.

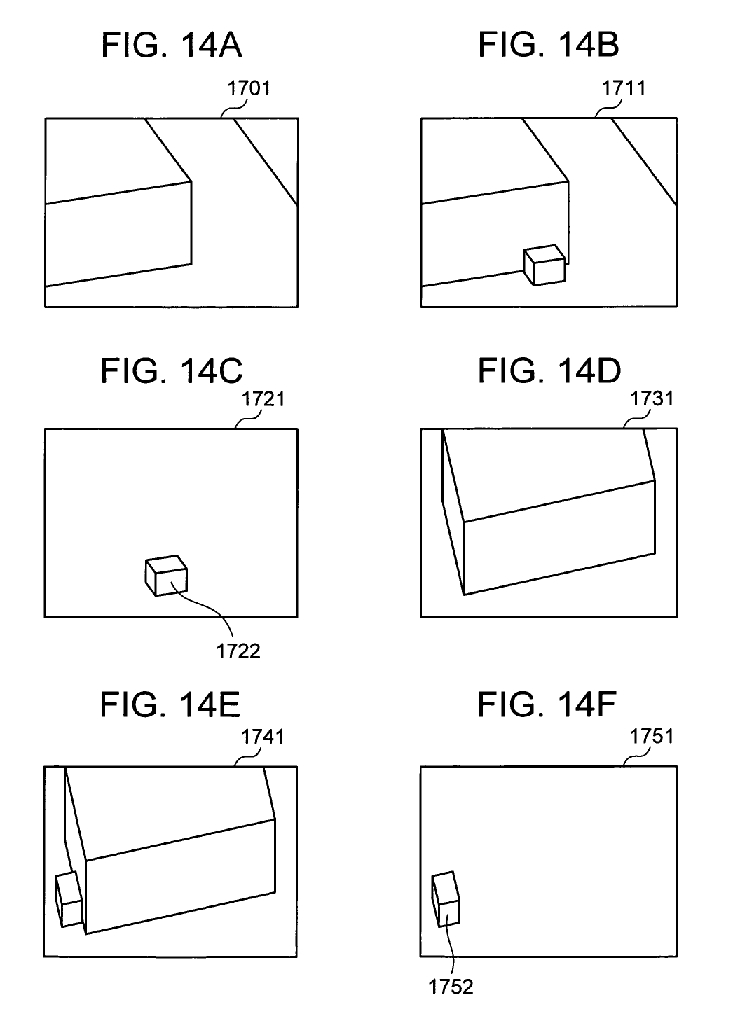

Now, a description will be given of the operational example of calculating the position of the abnormality occurrence portion on the basis of the conventional three-point measurement with reference to FIGS. 14A to 14F. Referring to FIGS. 14A to 14F, a description will be given of an example of reading the frame image which is given a flag indicating that the image has been taken with the fixed camera 11 of identification “aaa” on a date when no abnormality occurs, and the frame image of the image data on the date “2006.1.26 01:10” in which the latest image is taken, in the above-mentioned processing of S1601. An example of comparing those frame images will be described.

Referring to FIG. 14A, an image 1701 is an example of the frame image which is given a flag indicating that the image has been taken on a date when no abnormality occurs. Referring to FIG. 14B, an image 1711 is an example of the frame image which has been taken on the latest date “2006.1.26 01:10”. The abnormal part in image detecting section 915 calculates a differential image between the image 1701 and the image 1711 through the same operation as that in the conventional art. An example of the differential image is shown by a differential image 1721 of FIG. 14C. In the differential image 1721, an image 1722 is a pixel portion which remains due to a difference between the image 1701 and the image 1711. The abnormal part in image detecting section 915 calculates one of the two-dimensional positions within the place to be monitored 1 from the pixel position of the area which is large in the difference such as the image 1722 in the differential image 1721. In order to determine whether the area is large in the difference, or not, the abnormal part in image detecting section 915 conducts the determination, for example, according to whether the number of pixels of the difference within the given area is equal to or higher than a threshold value, or not.

In addition, the abnormal part in image detecting section 915 selects another fixed camera which takes the image including the calculated position. To achieve the above-mentioned operation, the abnormal part in image detecting section 915 selects the image-taking area 1003 including an area which is larger in the difference such as the image 1722 and the associated fixed camera 1001 from the fixed camera information memory section 922 of the memory device 903. Then, the abnormal part in image detecting section 915 reads the frame image which includes the identification information of the selected fixed camera 11 and is given a flag indicating that the image has been taken on a date when no abnormality occurs, and the frame of image data including the latest date from the taking image of fixed camera memory section 923 of the memory device 903. The abnormal part in image detecting section 915 calculates the differential image of the read image through the same operation as the above operational example, and calculates the other of the two-dimensional positions within the place to be monitored 1 from the pixel position having an area which is larger in the difference in the calculated image.

More specifically, for example, a description will be given of an example in which the fixed camera 1001 associated with the image-taking area 1003 including the area of the above-mentioned image 1722 is “ccc”. In this case, the abnormal part in image detecting section 915 reads the frame image which includes the identification information “ccc” and is given a flag indicating that the image has been taken on a date when no abnormality occurs, and the frame of image data which includes the identification information “ccc” and the date “2006.1.26. 01:10” in which the image is taken, from the taking image of fixed camera memory section 923 of the memory device 903. Referring to FIG. 14D, an image 1731 is an example of the frame image which is given a flag indicating that the image has been taken with the fixed cameral 1 of the identification information “ccc” on a date when no abnormality occurs. Referring to FIG. 14E, an image 1741 is an example of the frame image which has been taken with the fixed camera 11 of the identification information “ccc” on the latest date “2006.1.26 01:10”. The abnormal part in image detecting section 915 calculates a differential image between the image 1731 and the image 1741 through the same operation as that in the conventional art. An example of the differential image is shown by an image 1751 of FIG. 14F. In the differential image 1751, an image 1752 is a pixel portion which remains due to a difference between the image 1731 and theimage 1751. The abnormal part in image detecting section 915 calculates the other of the two-dimensional positions within the place to be monitored 1 from the pixel position having an area which is larger in the difference such as the image 1752 in the differential image 1751. The abnormal part in image detecting section 915 calculates the X-Y coordinates of the portion where the abnormality has occurred from the positions which are thus calculated from the respective two differential images.

Returning to FIG. 13, the abnormal part in image detecting section 915 stores the abnormality occurrence position which is calculated in S1604 in the abnormality occurrence position memory section 926 (S1605).

After conducting the above-mentioned processing on the image data of all the fixed cameras 11, the abnormal part in image detecting section 915 starts the movement route receiving section 917, and terminates its processing. The operational example of the movement route receiving section 917 will be described later.

Next, a description will be given of the operational example of detecting the abnormality from the sensor data which has been transmitted from the mobile monitoring camera device 13.

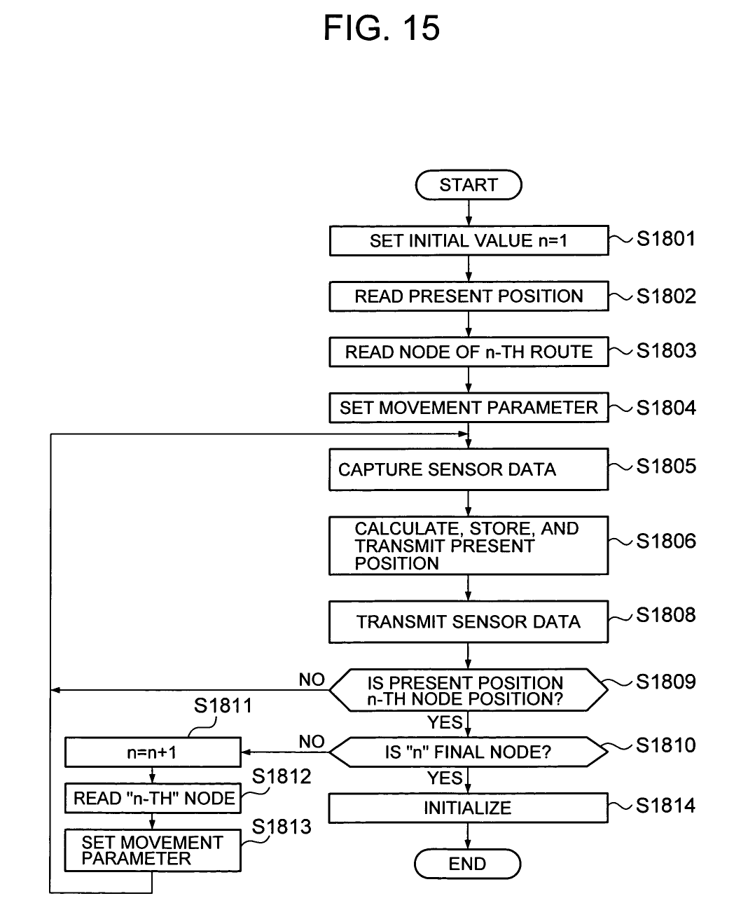

First, a description will be given of the operational example in which the mobile monitoring camera device 13 patrols the place to be monitored 1, and transmits the measured value which has been measured on a given position of the patrol route by the sensor 132 to the monitoring device 16 with reference to FIG. 15.

Referring to FIG. 15, the patrol processing section 217 of the control section 136 starts the operation of an example shown in FIG. 15. The patrol processing section 217 first initializes a variable. More specifically, “n=1” is set (S1801). Then, the patrol processing section 217 reads the present position of the mobile monitoring camera device 13 from the present position memory section 223 of the memory device 203 (S1802). In addition, the patrol processing section 217 reads a node position to be first directed among the patrol routes (S1803). To achieve the above-mentioned operation, for example, the patrol processing section 217 reads a position 402 which is associated with number 401 “n” from the patrol route memory section 224 of the memory device 203. In this embodiment, because of “n=1”, the patrol processing section 217 reads a position 402 which is associated with a number 401 “1”. Then, the patrol processing section 217 calculates the parameter which is to be given to the moving device 131 from the present position which is read in S1802 and the subsequent node position which is read in S1803, and stores the calculated parameter in the movement parameter memory section 228 (S1804). To achieve the above-mentioned operation, for example, the patrol processing section 217 stores an arbitrary velocity in a setting value 602 which is associated with an item 601 “velocity” in the movement parameter memory section 228. The velocity which is stored in the setting value 602 which is associated with the item 601 “velocity” may be different every time. In this embodiment, the same velocity is stored every time. Further, the patrol processing section 217 calculates the traveling direction from the X-Y coordinates of the present position which is read in S1802 and the X-Y coordinates which is read in S1803, and stores the calculated traveling direction in the setting value 602 which is associated with the item 601 “direction” in the movement parameter memory section 228. In this way, the patrol processing section 217 shifts to the stationary operation which will be described later after storing the calculated traveling direction in the movement parameter memory section 228.

On the other hand, the movement device control section 213 always refers to the movement parameter memory section 228 once every given period of time, for example, every 0.1 seconds, and performs control so as to operate the moving device 131 according to the parameter within the movement parameter memory section 228. More specifically, for example, the movement parameter memory section 228 operates the moving device 131 so as to set the velocity indicated by the setting value 602 which is associated with the item 601 “velocity”. Also, the movement parameter memory section 228 rotates the moving device 131 so as to be directed to a direction indicated by the setting value 602 which is associated with the item 601 “direction”. Therefore, when the movement parameter memory section 228 is updated by the above-mentioned operation of S1804, the movement device control section 213 operates the moving device 131 according to the updated parameter value.

The patrol processing section 217 executes the stationary operation, which will be described below as an example, once every given period of time, for example, every 0.5 seconds, after the initial operation, described above as an example, has been conducted.

The patrol processing section 217 captures the sensor data 132 (S1805). In this embodiment, the sensor 132 can conduct the measurement once every given period of time. In this embodiment, the sensor 132 conducts the measurement once every given period of time, for example, every 0.1 seconds, and the sensor data acquiring section 211 stores the measured value which has been measured by the sensor 132 in the sensor data memory section 222. The patrol processing section 217 reads the latest measured value from the sensor data memory section 222.

Next, the patrol processing section 217 instructs the present position calculating section 212 to calculate the present position. The present position calculating section 212 calculates the present position of the mobile monitoring camera device 13 from a difference between the map that is used for comparison, and the sensor data which is acquired in S1805, using the map in the vicinity of the present position that was calculated the previous time, according to the instruction, as the map used for the comparison, stores the present position in the present position memory section 223, and transmits the present position to the monitoring device 16 (S1806). The operational example of the present position calculation is identical with that described above. Upon receiving the present position from the mobile monitoring camera device 13, the present position data receiving section 913 of the monitoring device 16 stores the present position in the moving camera position memory section 925. In this situation, in cases where no date information is included in data from the mobile monitoring camera device 13, the positioning receiving section 913 adds the receiving date which has been acquired from the internal clock, and stores the data in the moving camera position memory section 925. This processing is conducted every time the present position data receiving section 913 receives the present position from the mobile monitoring camera device 13.

The patrol processing section 217 transmits the sensor data 132 on that position to the monitoring device 16 (S1808). To achieve the above-mentioned operation, the patrol processing section 217 transmits, for example, the measured value which is acquired in the above-mentioned step S1805 to the monitoring device 16. In this situation, the patrol processing section 217 transmits the measured value in association with the information indicative of the position at which the measured value has been measured. In this embodiment, the information indicative of the position at which the measured value has been measured is the present position which is calculated in S1806. The information indicative of the position at which the measured value has been measured is not limited to this, and may be, for example, the order of acquiring the measured value due to the sensor 132 on the patrol route.

After the above-mentioned processing of S1808, the patrol processing section 217 determines whether the present position coincides with an “n-th” node of the patrol route, or not (S1809). To achieve the above-mentioned operation, for example, the patrol processing section 217 reads a position 402 which is associated with an number 401 which coincides with the variable “n” from the patrol route memory section 224 of the memory device 203, and determines whether the value of the read position 402 coincides with the X-Y coordinate of the present position which has been calculated in the above-mentioned processing of S1806, or not.

In the case where the present position does not coincide with the “n-th” node on the patrol route as the result of determination in S1809, the patrol processing section 217 again conducts the above-mentioned processing of S1805 after a given period of time.

In cases where the present position coincides with the “n-th” node on the patrol route as the result of determination in S1809, the patrol processing section 217 determines whether the “n-th” node on the patrol route is a final node, or not (S1180). To achieve the above-mentioned operation, for example, the patrol processing section 217 determines whether the value of the variable “n” coincides with the maximum value of the number 401 within the patrol route memory section 224, or not. In the case where it is determined that the values coincide, the patrol processing section 217 determines that the “n-th” node on the patrol route is the final node.

In cases where the “n-th” node on the patrol route is not the final route as the result of determination in S1810, the patrol processing section 217 sets “n=n+1” (S1811), and reads the “n-th” node position in the patrol route (S1812). To achieve the above-mentioned operation, for example, the patrol processing section 217 reads the position 402 associated with the number 401 “n” from the patrol route memory section 224 of the memory device 203. Then, the patrol processing section 217 calculates the parameter which is given to the moving device 131 from the present position which has been calculated in S1806 and the node position which has been read in S1812, and stores the parameter in the movement parameter memory section 228 (S1813). The specific operational example is identical with the above-mentioned operation, and therefore its description will be omitted. Thereafter, the patrol processing section 217 again conducts the above-mentioned processing of S1805 after a given period of time.

In cases where the “n-th” node on the patrol route is the final route as the result of determination in S1810, the patrol processing section 217 initializes the mobile monitoring camera device 13 (S1814). The initialization is that, for example, a waiting position of the mobile monitoring camera device 13 is determined, and the final node of the patrol route of the patrol route memory section 224 is not the waiting position, the patrol processing section 217 reversely moves the patrol route within the patrol route memory section 224, and retrieves the shortest route up to a start point, returns to the waiting position, and stores the variable for stopping the moving device 131 in the movement parameter memory section 228. Also, for example, in cases where the waiting position of the mobile monitoring camera device 13 is not determined, or in cases where the final node of the patrol route of the patrol route memory section 224 is the waiting position, the patrol processing section 217 stores the variable for stopping the moving device 131 in the movement parameter memory section 228. In order to stop the moving device 131, the patrol processing section 217 stores, for example, “0” in the setting value 602 corresponding to the item 601 “velocity” in the movement parameter memory section 228. In this situation, the patrol processing section 217 may store an arbitrary value in the setting value 602 corresponding to the item 601 “direction” as the initial value, or may not store the arbitrary value therein.

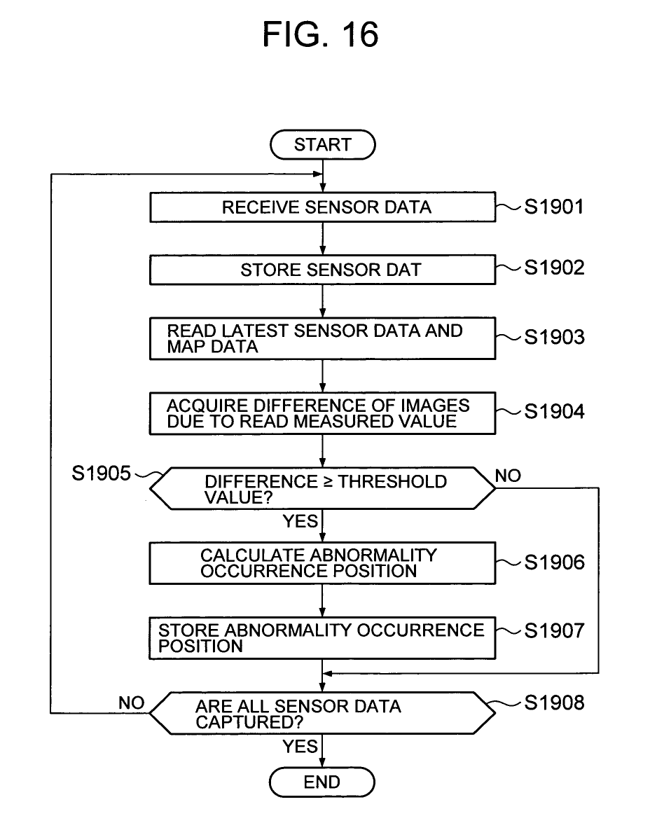

Next, a description will be given of an operational example of receiving the sensor data which has been transmitted from the mobile monitoring camera device 13 and detecting the abnormality from the sensor data with reference to FIG. 16. The operational example is identical with the above operational example shown in FIG. 13 except for partial operations, and therefore only the different operations will be described in detail, and the same operations will be omitted from the description.

The sensor data receiving section 914 of the monitoring device 16 starts up once every given period of time, or in cases of receiving the measured value from the mobile monitoring camera device 13, and conducts the operation shown in FIG. 16 as an example. First, upon receiving data including the sensor data and the sensing position from the mobile monitoring camera device 13 (S1901), the sensor data receiving section 914 stores the received data in the sensor data memory section 924 (S1902). In this situation, in the case where the measurement date is not included in the received data, the sensor data receiving section 914 acquires the receiving date from the internal clock, and stores the data in the sensor data memory section 924 together with the acquired date. Then, the sensor data receiving section 914 instructs the abnormal part in sensor data detecting section 916 to carry out processing.

The abnormal part in sensor data detecting section 916 reads the map within a given area from the position 1101 associated with the latest measurement date 1102 from the map data memory section 921. In addition, the abnormal part in sensor data detecting section 916 reads the sensor data which is associated with the latest date from the sensor data memory section 924 (S1903).

The abnormal part in sensor data detecting section 916 acquires a difference between the map which has been read in S1903 and the measured value (S1904). The difference is, for example, a differential image which is obtained by calculating a difference of the pixel at the same position between the map which has been read in S1903 and the image resulting from the measured value which has been read in S1903. The operational example of obtaining the differential image is identical with the image processing in the conventional art, and identical with the determination by means of the above-mentioned abnormal part in image detecting section 915.

The abnormal part in sensor data detecting section 916 determines whether the difference which has been calculated in S1904 is equal to or higher than a given threshold value, or not (S1905). The threshold value is, for example, the number of pixels of the differential image, and can be arbitrarily set according to the information which is inputted from the input device 904 or the communication interface 906. The determination is identical with the determination by the above-mentioned abnormal part in image detecting section 915.

In cases where the difference is equal to or higher than the threshold value as a result of the determination in S1905, the abnormal part in sensor data detecting section 916 determines that the abnormality occurs, and calculates the position of the abnormality occurrence portion (S1906). A technique for calculating the abnormality occurrence portion is not particularly limited, and in this embodiment, the position is calculated according to the differential image.

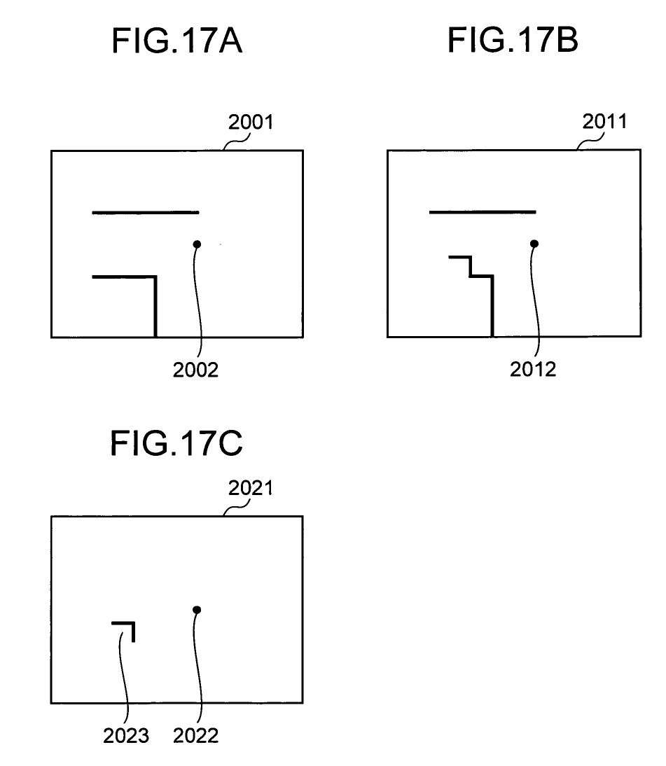

The operational example of calculating the position of the abnormality occurrence portion is identical with an example of the present position calculation by the above-mentioned present position calculating section 212. The operational example of calculating the position of the abnormality occurrence portion will be described with reference to FIGS. 17A to 17C. Referring to FIGS. 17A to 17C, a description will be given of an example of a case of comparing the map with the image data based on the measured value which has been measured on the measurement date “2006.1.26 01:10”.

Referring to FIG. 17A, an image 2001 is an example of the map which has been read from the map memory section 903. A point 2002 is the measured position of the mobile monitoring camera device 12. Referring to FIG. 17B, an image 2011 is an example of the image data resulting from the measured value which has been measured on a date “2006.1.26. 01:10”. A point 2012 is a position of the mobile monitoring camera device 13. The abnormal part in sensor data detecting section 916 calculates the differential image between the image 2001 and the image 2011 through the same operation as that in the conventional art. An example of the differential image is represented by a differential image 2021 of FIG. 17C. In the differential image 2021, a point 2022 is a position of the mobile monitoring camera device 13. An image 2023 is a pixel portion which remains due to the difference between the image 2001 and the image 2011. In this way, the abnormal part in sensor data detecting section 916 calculates the differential image between the image data based on the read latest measured value and the map, and calculates the two-dimensional X-Y position of the abnormality occurrence position within the place to be monitored 1 from the pixel position of an area with a larger differential and the position at which the measured value has been measured in the calculated image.

Returning to FIG. 16, the abnormal part in sensor data detecting section 916 stores the abnormality occurrence position which has been calculated in S1906 in the abnormality occurrence position memory section 926 (S1907).

In the whereas the difference is not equal to or higher than the threshold value as a result of the determination in S1905, or after the above-mentioned processing in S1907, the abnormal part in sensor data detecting section 916 determines whether all of the measured values to be acquired on the patrol route of the mobile monitoring camera device 13 have been received, or not (S1908). To perform the determination, the abnormal part in sensor data detecting section 916 determines whether the measured position which is included in the received data is identical with a predetermined value, or not. In this embodiment, the predetermined value is, for example, the maximum value of the number 401 within the patrol route memory section 224.

In the case where all of the measured values are not received as a result of the determination in S1908, the abnormal part in sensor data detecting section 916 stands by, and again waits for reception of an instruction from the sensor data receiving section 914.

In this embodiment, in cases where all of the measured values are not received as a result of the determination in S1908, and subsequent data is not received within a given period of time since the data is received through the above-mentioned processing of S1901, the sensor data receiving section 914 can output information indicating that all of the sensor data are not received, the positions at which the sensor data have been acquired up to now, and the positions at which the sensor datas are not acquired to the output device 905 such as a display.

In cases where all of the measured values are received as a result of the determination in S1908, the abnormal part in sensor data detecting section 916 completes the processing.

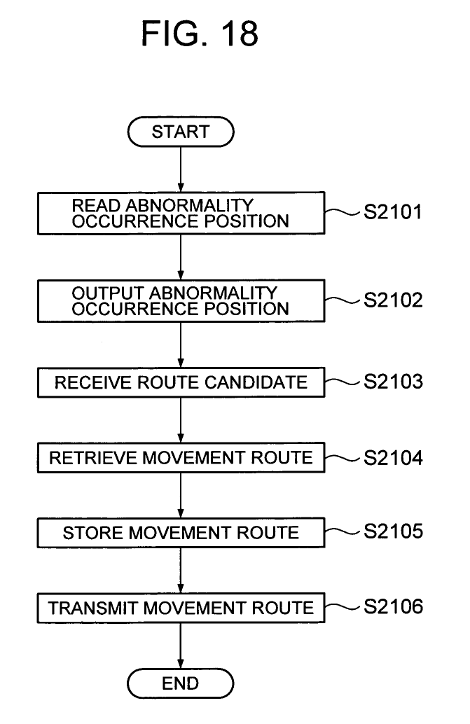

Through the above operational example, when the abnormality occurrence is detected in the place to be monitored 1, the movement route receiving section 917 is started by the abnormal part in image detecting section 915 or the abnormal part in sensor data detecting section 916. The operational example of the movement route receiving section 917 in this case will be described with reference to FIG. 18.

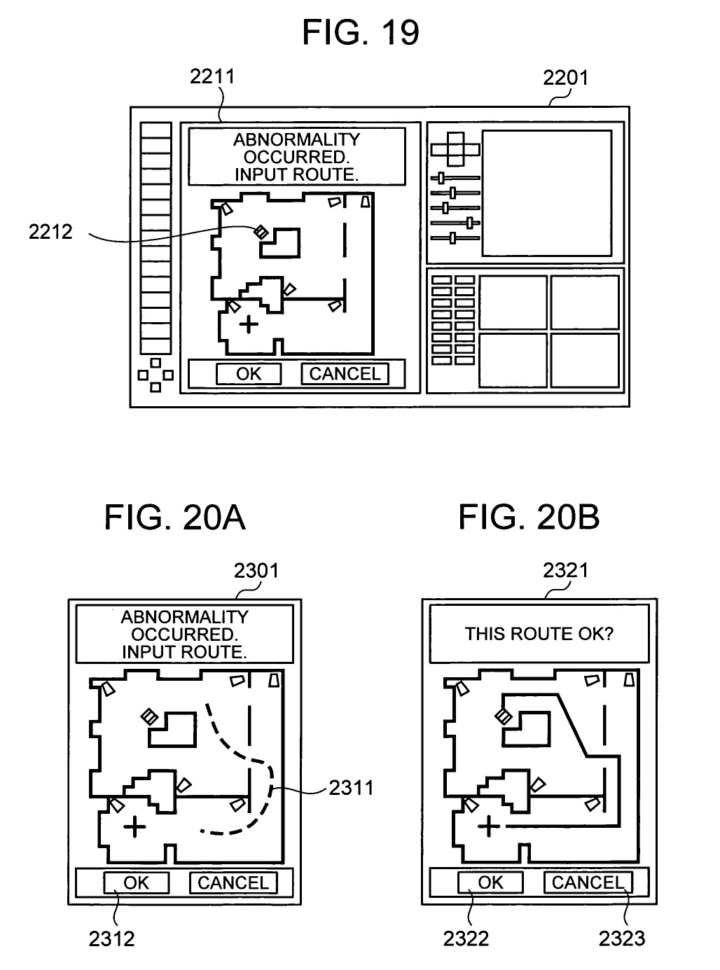

Referring to FIG. 18, the movement route receiving section 917 reads the abnormality occurrence position from the abnormality occurrence position memory section 926 within the memory device 903 (S2101), and outputs the read abnormality occurrence position as well as the map of the place to be monitored 1 to the output device 905 (S2102). In this embodiment, an example in which the abnormality occurrence position is outputted to the display is shown in FIG. 19. Referring to FIG. 19, a screen 2201 is an example of displaying the map of the place to be monitored 1 shown in FIG. 3 as an example, and the abnormality occurrence position. In the screen 2201, the sub-screen 2211 is an area on which the map of the place to be monitored 1 is displayed. In the sub-screen 2211, reference numeral 2212 denotes an abnormality occurrence position. For example, the movement routine receiving section 917 defines the abnormality occurrence position which has been read in the above-mentioned processing of S2101 on the map of the read place to be monitored 1, synthesizes the resultant, to display the map.

At this point, the movement route receiving section 917 may superimpose the mobile monitoring camera device 13 having the same reduction scale as the map to be displayed on the map of the place to be monitored 1, and display the map on the sub-screen 2211. Also, it is possible that a region through which the mobile monitoring camera device 13 cannot pass among the paths within the place to be monitored 1 is superimposed on the map, and displayed on the sub-screen 2211. To perform the above-mentioned operation, for example, it is possible that the data of the sub-contour which is offset toward the inside by a distance half or more as large as the size of the mobile monitoring camera device 13 is stored in the map data memory section 921 in advance, and the movement route receiving section 917 superimposes the data of the sub-contour on the map of the place to be monitored 1 and displays the data on the map through the processing of S2102. With the above-mentioned operation, it is easy for the observer to recognize the region through which the mobile monitoring camera device 13 cannot pass among the paths within the place to be monitored 1.

Also, in this embodiment, the output of the abnormality occurrence position is not limited to the output device 905 of the monitoring device 16, but may be outputted to another processing terminal (not shown), which is connected through the communication interface 906, or the like. In this case, the route information which has been transmitted from the processing terminal can be received as the route which will be described below.

Returning to FIG. 18, the movement route receiving section 917 receives the input of the route along which the mobile monitoring camera device 13 moves to the abnormality occurrence route (S2103). The route is inputted by, for example, specifying a line or a point on the sub-screen 2211 shown in FIG. 19 as an example using the input device 904 through the observer.

Next, the movement route receiving section 917 retrieves the movement route along which the mobile monitoring camera device 13 is supposed to move on the basis of the present position of the mobile monitoring camera device 13, the route which is received in S2103, and the abnormality occurrence position which is read in S2101 (S2104), and then stores the retrieved movement route in the route memory section 927 (S2105). A technique for retrieving the route is not limited, but in this embodiment, the route is retrieved according to the A*retrieval algorithm of the conventional art. In other words, the movement route receiving section 917 reads the present position of the mobile monitoring camera device 13 from the moving camera position memory section 925. Then, the movement route receiving section 917 selects a route whose costs are minimal among the routes which set the present position of the mobile monitoring camera device 13, which has been read, as a start position, and set the abnormality occurrence position, read in S2101, as an end position, through the A*retrieval algorithm, to determine a route along which the mobile monitoring camera device 13 is supposed to move. The costs are calculated, for example, on the basis of a distance from the X-Y coordinates of the route which is inputted in S2103, and the total distance of the paths. In this embodiment, the movement route receiving section 917 outputs the retrieved movement route to the output device 905, and in cases where the movement instruction on the route is inputted from the observer, the movement route receiving section 917 can conduct the processing described below. The abnormal part in sensor data detecting section 916 stores plural nodes of the retrieved movement route in the route memory section 927.

The operational example will be described with reference to FIGS. 20A and 20B. A sub-screen 2301 of FIG. 20A is an example of inputting the route by the observer in the above-mentioned sub-screen 2211 shown in FIG. 19. In the sub-screen 2301, the line 2311 expresses a route which the observer inputs using the input device 904 such as a mouse. In this way, the route inputted in S2103 does not always connect the mobile monitoring camera device 13 and the abnormality occurrence position. The observer depresses the button 2312 by using the input device 904 to instruct the retrieval of the route. The abnormal part in sensor data detecting section 916 retrieves the route according to the A*retrieval algorithm, and acquires the X-Y coordinates of the plural nodes on the retrieved route.

Next, the abnormal part in sensor data detecting section 916 displays a sub-screen 2321 shown in FIG. 20B as an example on the display. A sub-screen 2321 is an example of combining the retrieved route with the map and displaying the retrieved route. In the sub-screen 2321, the observer presses a button 2322 or a button 2323 using the input device 904, to thereby input information indicating whether the movement on the route is acceptable or not. In this embodiment, in cases where the button 2323 is pressed, and the displayed route is not permitted, the abnormal part in sensor data detecting section 916 can display the routes whose costs are not minimal among the retrieved routes as the routes of the mobile monitoring camera device 13, through the same operation as that described above, or may receive the input of the route by the observer again. In the case where the button 2322 is pressed, and the displayed route is permitted, the abnormal part in sensor data detecting section 916 stores the X-Y coordinates of the node on the retrieved route in the route memory section 927.

Referring to FIG. 18, the abnormal part in sensor data detecting section 916 reads the plural X-Y coordinates indicative of the routes from the moving camera position memory section 925, and then transmits the read X-Y coordinates and the pass order of the X-Y coordinates to the mobile monitoring camera device 13 together with the movement instruction (S2105).

In the above example, the destination of the movement route is the abnormality occurrence position, but the present invention is not limited thereto. It is possible for the observer to determine the destination of the movement route to an arbitrary position. In this case, it is preferable that the observer inputs the destination of the movement route through the above-mentioned processing of S2103. It is preferable that the movement route receiving section 917 conducts the same processing as that described above on the inputted destination, and retrieves the movement route.

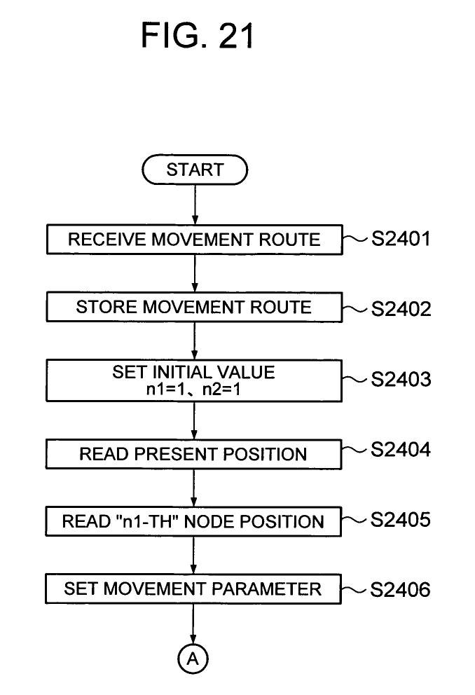

On the other hand, the mobile monitoring camera device 13 stops in a situation other than the above-mentioned initial position calculation and the route patrol, and stands by. Upon receiving the movement instruction including the route, the movement processing section 218 starts up, and starts to move according to the transmitted movement route through the above operational example. The operational example will be described with reference to FIG. 21.

FIG. 21 is an operational example of the time when the movement processing section 218 starts. Referring to FIG. 21, upon receiving the movement instruction including the route from the monitoring device 16 (S2401), the movement processing section 218 stores the route included in the received route instruction in the movement route memory section 226 (S2402). To perform the above-mentioned operation, for example, the movement processing section 218 extracts plural combinations of the order and the X-Y coordinates indicative of a node through which the route passes in that order, from the received data, stores the extracted order in the number 401 of the movement route memory section 226 for each of the combinations, and stores the extracted X-Y coordinates at the position 402 corresponding to the number 401. The movement processing section 218 conducts the above-mentioned processing on the combination of all the orders and the X-Y coordinates which are included in the movement instruction.

Next, the movement processing section 218 sets the initial value. More specifically, for example, “n1=1” and “n2=1” are set (S2403). The “n1” is a variable indicative of the order of the node on the movement route which has been transmitted from the monitoring device 16. The “n2” is a variable indicative of the order of the nodes on the avoidance route which is retrieved through an operation which will be described later.

Next, the patrol processing section 217 reads the present position from the present position memory section 223 of the memory device 203 (S2404), and reads the node position to be directed to the “n1-th” from the movement route memory section 226 (S2405). To perform the above-mentioned operation, for example, the movement processing section 218 reads the position 402 which is associated with the number 401 which coincides with “n1” from the present position memory section 223. Then, the movement processing section 218 calculates the parameter which is given to the moving device 131 on the basis of the present position which is read in S2404 and the position which is read in S2405, and stores the parameter in the movement parameter memory section 228 (S2406). The operational example is identical with that described above, and its description will be omitted.

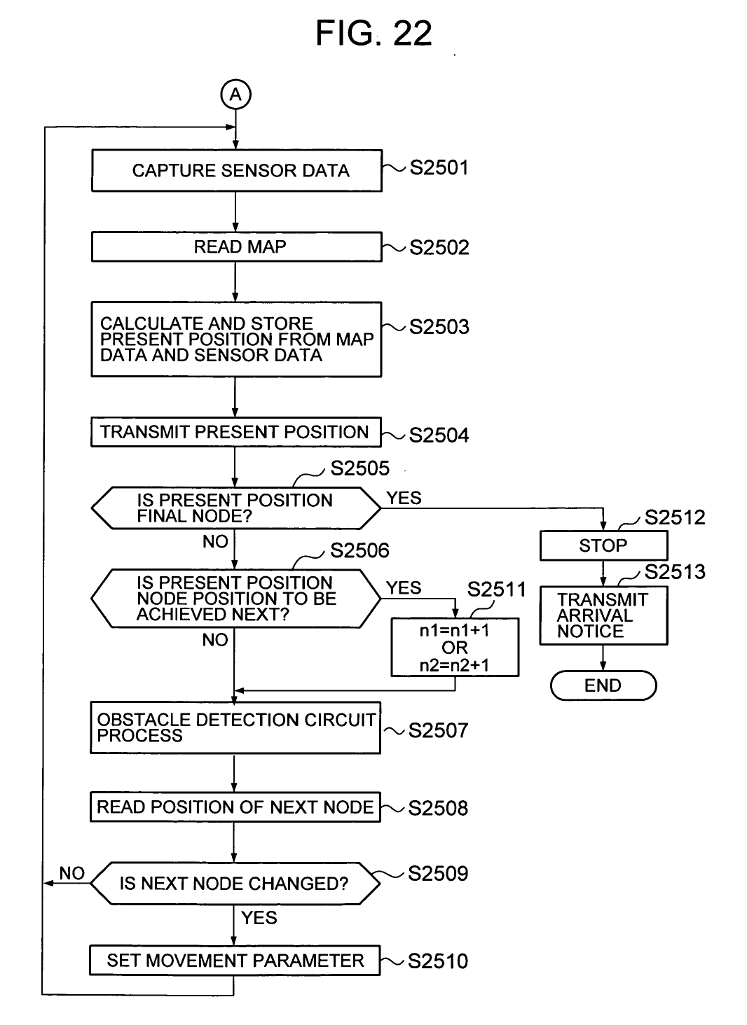

Then, the movement processing section 218 shifts to normal operation. An example of the normal operation will be described with reference to FIG. 22. The processing starts up once every given period of time, for example, every 0.5 seconds. The operational example to be described below is partially identical with the above operational example described with reference to FIG. 15, and therefore redundant descriptions will be omitted.

The movement processing section 218 captures the value measured by the sensor 132 (S2501). The specific operational example is identical with that described above.

Next, the movement processing section 218 reads the map in the vicinity of the present position which has been calculated previously from the map memory section 221 (S2502). The specific operational example is identical with that described above.

The movement processing section 218 instructs the present position calculating section 212 to calculate the present position. The present position calculating section 212 calculates the present position through the same operational example as that described above, and stores the present position in the present position memory section 223 (S2503). The specific operational example is identical with that described above.

The movement processing section 218 reads the calculated present position from the present position memory section 223, and transmits the present position to the monitoring device 16 (S2504) Then the movement processing section 218 determines whether the present position is a final node, or not (S2505). In this embodiment, the final node may be a node of the movement route or a node of the avoidance route. The movementprocessing section 218 determines whether the avoidance route is stored in the avoidance route memory section 227, or not, or whether the avoidance route is set, or not, with reference to the given flag. In the case where the avoidance route is set, the movement processing section 218 reads the position 402 which is associated with the maximum value of the number 401 from the avoidance route memory section 227 within the memory device 203, and determines whether the present position which has been calculated in the above-mentioned processing of S2503 coincides with the position 402, or not. Also, in the case where no avoidance route is set, the movement processing section 218 reads the position 402 which is associated with the maximum value of the number 401 from the movement route memory section 226 within the memory device 203, and determines whether the present position which has been calculated in the above-mentioned processing of S2503 coincides with the position 402, or not. In the case of coincidence, the movement processing section 218 determines that the present position is the final node.

In cases where the present position is not the final node as a result of the determination in S2505, the movement processing section 218 determines whether or not the present position coincides with a node at which the route is supposed to arrive at next (S2506) In this embodiment, as described above, the node at which the route arrives at next may be the “n1-th” node on the movement route or the “n2-th” node on the avoidance route. The movement processing section 218 determines whether the avoidance route is set in the same operational example as that described above, or not. In the case where the avoidance route is set, the movement processing section 218 reads the position 402 which is associated with the number 401 “n2” from the avoidance route memory section 227 within the memory device 203. Then the movement processing section 218 determines whether the present position which is calculated in the above-mentioned processing of S2503 coincides with the position 402, or not. Also, in cases where no avoidance route is set, the movement processing section 218 reads the position 402 which is associated with the number 401 “n1” from the movement route memory section 226 within the memory device 203, and determines whether the present position which is calculated in the above-mentioned processing of S2503 coincides with the position 402, or not. In the case of coincidence, the movement processing section 218 determines that the present position coincides with the node at which the route is supposed to arrive at next.

In cases where the present position does not coincide with the node at which the route is supposed to arrive at next as a result of the determination in S2506, the movement processing section 218 detects an obstacle on the node to be headed for next, and conducts the avoiding process (S2507).

FIG. 22 After processing in S2507, the movement processing section 218 acquires the X-Y coordinates of the node to be to be headed for next (S2508). The movement processing section 218 determines whether the avoidance route is set or not, through the same operational example as that described above. In cases where the avoidance route is set, the movement processing section 218 reads a position 402 which is associated with the number 401 “n2” from the avoidance route memory section 227 within the memory device 203. Also, in cases where no avoidance route is set, the movement processing section 218 reads the position 402 which is associated with the number 401 “n1” from the movement route memory section 226 within the memory device 203. The movement processing section 218 sets the read X-Y coordinates as the X-Y coordinates to be headed for.

Then, the movement processing section 218 determines whether the subsequent node position is changed, or not (S2509). To perform the determination, the movement processing section 218 determines whether or not the position of the subsequent node which is read in S2508 coincides with the node position which is read in the above-mentioned processing of S2601. In cases of no coincidence as a result of the determination, the movement processing section 218 determines that the subsequent node position is changed.

In cases of coincidence as a result of the determination in S2509, the movement processing section 218 calculates the parameters of the moving device 131 so as to move to a node which is read in S2508, and then stores the calculated parameters in the movement parameter memory section 228 (S2510). The operational example is identical with that described above, and its description will be omitted.

In cases where there is no change in the subsequent node position as a result of the determination in S2509, the movement processing section 218 terminates the present processing, and starts again after a given period of time.

On the other hand, in cases where the present position coincides with the “n1-th” or “n2-th” node as a result of the determination in the above-mentioned step S2506, the movement processing section 218 satisfies “n1=n1+1” or “n2=n2+1” (S2511). Then the movement processing section 218 conducts the processing of S2507. The subsequent operation is identical with that described above.

On the other hand, in cases where the present position is the final node on the movement route as a result of the above-mentioned determination in S2505, the movement processing section 218 stores a variable for stopping the moving device 131 in the movement parameter memory section 228 (S2512). The operational example for the above-mentioned processing is identical with that described above. Then the movement processing section 218 transmits the information which notifies the monitoring device 16 (S2513) of arrival at the abnormality occurrence position.

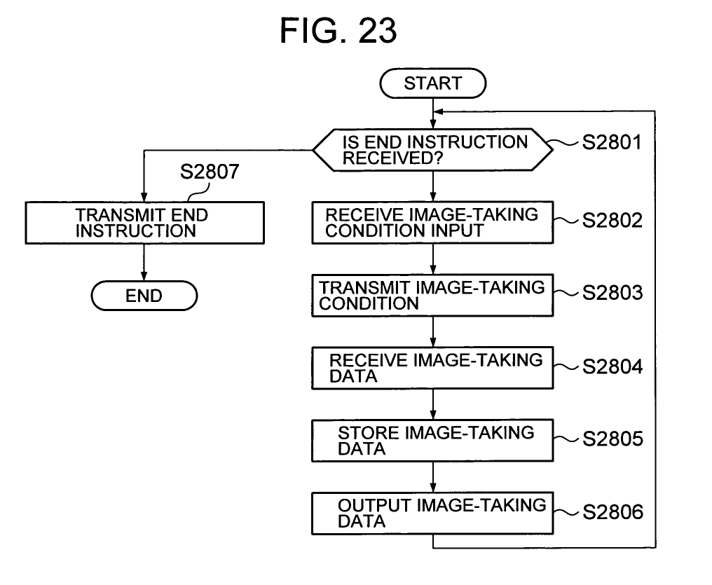

Next, a description will be given of an operational example of instructing the image-taking to the mobile monitoring camera device 13 with reference to FIG. 23. The operation can start at an arbitrary timing, for example, when the mobile monitoring camera device 13 stops, when the mobile monitoring camera device 13 moves along the patrol route, in cases where the monitoring device 16 is moving along the movement route, or after the monitoring device 16 has arrived at the abnormality occurrence position. Upon input of the image-taking instruction, the image-taking instruction receiving section 918 of the monitoring device 16 starts the following operational example.

The image-taking instruction receiving section 918 of the monitoring device 16 determines whether or not the image-taking end instruction has been received (S2801). When the observer is going to terminate the image-taking, the observer presses a button which is displayed on a display to give an instruction for termination. Upon input of the termination instruction, the image-taking instruction receiving section 918 changes a flag indicating whether or not the termination instruction has been inputted, to a flag indicating that the termination instruction has been inputted. The image-taking instruction receiving section 918 conducts the determination of step S2801 with reference to the flag.

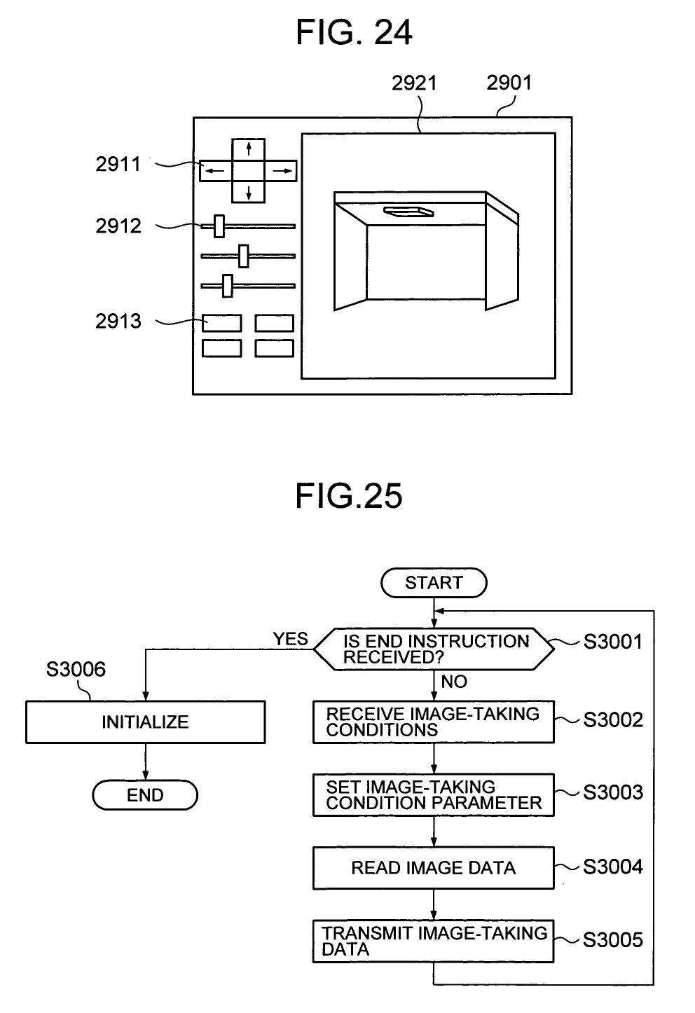

In cases where the image-taking termination instruction is not received as a result of the determination in S2801, the image-taking instruction receiving section 918 receives the image-taking conditions (S2802). To perform the above-mentioned operation, the image-taking instruction receiving section 918 receives the parameter which has been inputted from a screen indicated by a sub-screen 2901 of FIG. 24 as an example, which is outputted to the output device 905 such as a display as the image-taking conditions. Referring to FIG. 24, the sub-screen 2901 includes a display area 2921, a direction button 2911, an image-taking parameter setting button 2912, and an image-taking instruction button 2913. The direction button 2911 serves as means which instructs the parameters for panning and tilting of the camera 134. The image-taking parameter setting button 2912 serves as means which inputs parameters such as the luminance of the lighting 133 or the height of the telescopic pole 135. The image-taking instruction button 2913 serves as means which instructs the start and end of the image-taking by means of the camera 134, and on and off switching of the lighting 133. An image which has been taken with the camera 134 is displayed on the display area 2921. The observer presses the direction button 2911 and the image-taking parameter setting button 2912 using the input device 904 such as a mouse, to input the image-taking conditions. Also, the observer presses the image-taking instruction button 2913 using the input device 904 such as a mouse, to instruct the start of image-taking, the end of image-taking, and the on and off switching of the lighting 133.

The image-taking instruction receiving section 918 transmits the image-taking conditions which are received in S2802 to the mobile monitoring camera device 13 (S2803). The mobile monitoring camera device 13 takes an image under the transmitted image-taking conditions through the operational example which will be described later, and transmits the taken data to the monitoring device 16.

Upon receiving the image data from the mobile monitoring camera device 13 (S2804), the taking image of moving camera memory section 919 stores the image data in the taking image of moving camera memory section 930 of the memory device 903 (S2805), and outputs the image data to the output device 905 such as the display (S2806). More specifically, for example, the taking image of moving camera memory section 919 displays the image which has been read from the taking image of moving camera memory section 930 in the display area 2921, shown in FIG. 24 as an example. Thereafter, the taking image of moving camera memory section 919 returns to the processing of S2801.

On the other hand, in the case where the end instruction has been inputted as a result of the above-mentioned determination in S2801, the image-taking instruction receiving section 918 transmits the end instruction to the mobile monitoring camera device 13 (S2807), and terminates the processing.

Now, a description will be given of the operational example of the image-taking mobile monitoring camera device 13 with reference to FIG. 25. The image-taking processing section 219 of the control section 136 starts up and starts the following processing in cases of receiving the image-taking instruction which has been transmitted from the monitoring device 16. In this situation, the image-taking processing section 219 sets the setting value 702 corresponding to the item 701 “on/off” of the image-taking parameter memory section 229 to “on”. Further, the image-taking processing section 219 sets the setting value 802 corresponding to the item 801 “on/off” of the lighting parameter memory section 230 to “on”.

The image-taking processing section 219 of the control section 136 determines whether the end instruction which has been transmitted from the monitoring device 16 is received, or not (S3001). The specific example is identical with that described above.

In the case where the end instruction is not received as a result of the determination in S3001, the image-taking processing section 219 receives the image-taking conditions (S3002), and stores the parameters which are extracted from the received image-taking conditions in the image-taking parameter memory section 229, and the lighting parameter memory section 230 (S3003).

On the other hand, the image-taking device control section 214 always refers to the image-taking parameter memory section 229 every given period of time, and controls the camera 134 and the telescopic pole 135 according to the parameter within the image-taking parameter memory section 229. In the same manner, the lighting control section 215 always refers to the lighting parameter memory section 230 every given period of time, and controls the lighting 133 according to the parameter within the lighting parameter memory section 230. In cases where the setting value 702 corresponding to the item 701 “on/off” of the image-taking parameter memory section 229 is “on”, the image-taking device control section 214 controls the camera 134 so that it is set as indicated by the setting value 702 corresponding to the respective items 701 “pan”, “tilt”, and “zoom”. Further, the image-taking device control section 214 controls the telescopic pole 135 so that it is set as indicated by the setting value 702 corresponding to the item 701 “height”. The image-taking device control section 214 stores the image data which has been taken in the above-mentioned setting in the image memory section 231. Also, in the case where the setting value 802 corresponding to the item 801 “one/off” of the lighting parameter memory section 230 is “on”, the lighting control section 215 controls the lighting 133 so that it is set as indicated by the setting value 802 corresponding to the item 801 “luminance”.

The image-taking processing section 219 reads the taken image data from the image memory section 231 (S304), and transmits the image data to the monitoring device 16 (S3005). At this point, the image-taking processing section 219 can transmit the present position which is read from the present position memory section 223 together with the image data.

In cases where the end instruction is not received as a result of the determination in S3001, the image-taking processing section 219 initializes the parameters within the image-taking parameter memory section 229 and the lighting parameter memory section 230, and terminates the processing (S3006). In the initialization, for example, the image-taking processing section 219 sets the setting value 702 corresponding to the item 701 “on/off” of the image-taking parameter memory section 229 to “off”. In this embodiment, the image-taking processing section 219 may store the initial value in the setting value 230 corresponding to another item 701 of the image-taking parameter memory section 229. In addition, the image-taking processing section 219 sets the setting value 802 corresponding to the item 801 “on/off” of the lighting parameter memory section 230 to “off”. Likewise, the image-taking processing section 219 may store the initial value in the setting value 802 corresponding to another item 801 of the lighting parameter memory section 230.

As described above, in the technique of this embodiment, it is possible to control the movement of the mobile monitoring camera device by merely inputting the movement route of the mobile monitoring camera device once. As a result, it is unnecessary for the observer to constantly operate the mobile image-taking device. Also, it is unnecessary to locate an RFID or a sensor in the place to be monitored. In addition, the present autonomous movement technique is incomplete and has not reached a level for practical use, but the technique of this embodiment can be put to practical use because a rough movement route is indicated in advance, with only the avoidance of the obstacle on the movement route is processed by the mobile monitoring camera device.

The embodiment has been described above in detail, with reference to the drawings. However, the specific configuration is not limited to this embodiment, and the design can be changed within a scope which does not deviate from the gist of the present invention.

For example, as described above, the abnormality may be detected not only from the value measured by the sensor 132 when patrolling the place to be monitored 1, but also from the image taken by the camera 134 when patrolling the place to be monitored 1.

Also, in this embodiment, the abnormal part in image detecting section 915 compares image data which has been taken on a date when no abnormality occurs with the image data on the date in which the latest image is taken, to detect the abnormality. However, the present invention is not limited thereto. The abnormal part in image detecting section 915 compares the image data taken on different dates with each other to detect the abnormality, and the image data taken on the different dates may be, for example, the image data immediately after the last person exits the place to be monitored 1, and the latest image data.

Also, in the above embodiment, the monitoring device 16 retrieves the movement route on the basis of the inputted route, but the present invention is not limited to this configuration, and it is possible to transmit the inputted route itself as the movement route to the mobile monitoring camera device 13.

Also, in the above embodiment, the movement route is transmitted from the monitoring device 16. Alternatively, the mobile monitoring camera device 13 may retrieve the movement route. In this case, the observer inputs the route through the same operation as that described above using the input device 904 of the monitoring device 16, or the input device of a processing terminal (not shown), and then transmits the inputted route to the mobile monitoring camera device 13. The mobile monitoring camera device 13 retrieves the movement route from the received route through the same operation as that of the above-mentioned monitoring device 16.

Also, the above-mentioned system can be applied not only to the monitoring system, but also to, for example, a load carriage in a factory, a toy, or an amusement field.

According to the present invention, the mobile monitoring device which calculates its present position can move according to the inputted route and can arrive at the destination. As a result, the mobile monitoring device can move along a desired route by merely inputting the movement route once. As a result, it is unnecessary that the observer constantly operate the mobile image-taking device. Also, it is unnecessary to locate an RFID or a marker in a place to be monitored.

What is claimed is:

1. A monitoring system, comprising:
a mobile monitoring device having moving means which moves in a place to be monitored; and
a monitoring device which is connected to the mobile monitoring device via a communication network;
the monitoring device comprising:
monitor map memory means which stores map of a place to be monitored;
display means which displays the map which is read from the monitor map memory means;
input means; and
movement route transmitting means which transmits a route of the mobile monitoring device, which is inputted by the input means, to the mobile monitoring device;
the mobile monitoring device comprising:
movement control means which controls the moving means;
present position calculating means which calculates present position; and
movement route receiving means which receives the transmitted route;
wherein the moving means is controlled according to the calculated present position and the received route.

2. A monitoring system, comprising:
a mobile monitoring device having moving means which moves in a place to be monitored; and
a monitoring device which is connected to the mobile monitoring device via a communication network;
the monitoring device comprising:
monitor map memory means which stores map of a place to be monitored;
display means which displays the map which is read from the monitor map memory means;
input means; and
movement route transmitting means which transmits a route of the mobile monitoring device which is inputted by the input means, to the mobile monitoring device;
the mobile monitoring device comprising:
movement monitoring map memory means which stores the map of the place to be monitored;
setting value memory means which stores a setting value which determines at least one of the velocity and the traveling orientation of the moving means;
movement control means which controls the moving means according to the setting value which is read from the setting value memory means;
present position calculating means which calculates a present position from the map which is read from the movement monitoring map memory means;
route receiving means which receives the transmitted route; and
movement processing means;
wherein the movement processing means calculates a value of the setting value from the calculated present position and the received route, and stores the setting value in the setting value memory means.

3. A monitoring system according to claim 2,
wherein a fixed camera is located in the place to be monitored;
wherein the fixed camera has fixed camera image transmitting means which transmits the taken image to the monitoring device;
wherein the monitoring device further comprises:
fixed camera image memory means which stores the taken image from the fixed camera in a state with no abnormality;
fixed camera image receiving means which receives the image which is transmitted from the fixed camera;
abnormality detecting means which reads the taken image from the fixed camera in the state with no abnormality, from the fixed camera image memory means, and determines whether there is an abnormality, or not, according to whether or not a difference exists between the read image and the received image; and
abnormality occurrence position calculating means which calculates a position at which the abnormality occurs, from the position of the difference; and
wherein the display means displays the map and the calculated abnormality occurrence position.

4. A monitoring system according to claim 2,
wherein the mobile monitoring device further comprises:
a sensor which measures distance between the sensor and an object;
transmitting means which transmits, to the monitoring device, a measured value which is measured by the sensor at a specific location of the place to be monitored;
wherein the monitoring device further comprises:
measured value receiving means which receives the measured value which is transmitted from the mobile monitoring device;
abnormality detecting means which determines whether or not there is an abnormality, according to whether or not a difference exists between the map which is read from the monitor map memory means and the measured value which is received; and
abnormality occurrence position calculating means which calculates a position at which the abnormality occurs from a position of the difference and a position of the specific location; and
wherein the display means displays the map and the calculated abnormality occurrence position.

5. A monitoring system according to claim 2,
wherein the monitoring device further comprises image-taking condition transmitting means which transmits an image-taking setting value indicative of a condition under which an image is taken, input by the input means;
wherein the mobile monitoring device further comprises:
a camera;
image-taking setting value memory means which stores the setting value in taking an image by the camera;
camera control means which controls the camera according to the setting value which is read from the image-taking setting value memory means; and
image-taking condition receiving means which receives the transmitted image-taking setting value; and
wherein the image-taking condition receiving means stores the received image-taking setting value in the image-taking setting value memory means.

6. A monitoring system according to claim 2,
wherein the mobile monitoring device further comprises:
a sensor which measures a distance between the monitoring device and an object;
obstacle detecting means which determines whether or not there exists an obstacle on the received route, according to the received route, the calculated present position, a dimension of the monitoring device, and the distance between the monitoring device and the object, which is measured by the sensor; and
avoidance route retrieving means which retrieves an avoidance route having a distance to the object which is equal to or higher than the dimension in cases where the obstacle detecting means determines that there is an obstacle; and
wherein the movement processing means calculates the value of the setting value from the calculated present position and the retrieved avoidance route, and stores the setting value in the setting value memory means.

7. A monitoring system according to claim 4,
wherein the mobile monitoring device further comprises:
obstacle detecting means which determines whether or not there exists an obstacle on the received route, from the the received route, the calculated present position, a dimension of the monitoring device, and the distance between the monitoring device and the object which is measured by the sensor; and
avoidance route retrieving means which retrieves an avoidance route having a distance to the object which is equal to or higher than the dimension, in cases where the obstacle detecting means determines that there is an obstacle; and
wherein the movement processing means calculates the value of the setting value according to the calculated present position and the retrieved avoidance route, and stores the setting value in the setting value memory means.

8. A monitoring method for a monitoring system including: a
mobile monitoring device having moving means which moves in a place to be monitored; and a monitoring device which is connected to the mobile monitoring device via a communication network,
the monitoring device having monitor map memory means which stores map of the place to be monitored, display means, and input means,
the mobile monitoring device having a movement monitoring map memory means which stores the map on the place to be monitored, the monitoring method comprising:
a displaying step of displaying, on the display means, map which is read from the monitor map memory means;
a movement route transmission step of transmitting to the mobile monitoring device, a route of the mobile monitoring device which is inputted by the input means;
a present position calculating step of calculating a present position from the map which is read from the movement monitoring map memory means;
a route receiving step of receiving the transmitted route; and
a controlling step of calculating a value of a setting value from the calculated present position and the received route, and controlling the moving means according to the calculated setting value.

9. A monitoring program for a monitoring system including: a mobile monitoring device having moving means which moves in a place to be monitored; and a monitoring device which is connected to the mobile monitoring device via a communication network,
the monitoring program causing the monitoring device having monitor map memory means which stores the map on the place to be monitored, display means, and input means, to execute:
a displaying step of displaying, on the display means, map which is read from the monitor map memory means; and
a movement route transmission step of transmitting, to the mobile monitoring device, a route of the mobile monitoring device which is inputted from the input means
the monitoring program causing the mobile monitoring device, having movement monitoring map memory means which stores the map on the place to be monitored, to execute:
a present position calculating step of calculating a present position from the map which is read from the movement monitoring map memory means;
a route receiving step of receiving the transmitted route; and
a controlling step of calculating a value of a setting value according to the calculated present position and the received route, and controlling the moving means according to the calculated setting value.
